(19) United States
(12) Patent Application Publication
(10) Pub. No.: US 2026/0255281 A1
(43) Pub. Date: Aug. 27, 2026

(54) WIRELESS LOCAL AREA NETWORK THROUGHPUT AND COVERAGE WITH ENHANCED SPECIFIC ABSORPTION RATE

(71) Applicant: QUALCOMM Incorporated, San Diego, CA (US)

(72) Inventors: Liang XU, Shanghai (CN); Zhicheng ZHANG, Suzhou (CN); Huafeng FAN, Shanghai (CN); Yuting RUAN, Shanghai (CN); Yingyong WENG, Shanghai (CN)

(21) Appl. No.: 18/992,127

(22) PCT Filed: Aug. 16, 2022
(86) PCT No.: PCT/CN2022/112671

§ 371 Date: Jan. 7, 2025

(51) Int. Cl. H04W 52/36; H04L 5/00; H04W 52/02

(52) U.S. Cl. CPC H04W 52/367; H04L 5/0051; H04W 52/0245

(57) ABSTRACT

Methods, systems, and devices for wireless communications are described. An access point (AP) and a station (STA) may communicate frames in accordance with a specific absorption rate (SAR) limit. An AP or STA may suspend or modify an SAR limit to support communicating frames having relatively higher transmission powers. For example, the AP or STA may modify an SAR limit for a time interval (for example, a time-averaged SAR limit) such that the AP or STA may increase a transmission power of a data frame. In some examples, the AP or STA may modify a duty cycle associated with the data frame based on modifying the SAR limit for the time interval. Additionally or alternatively, the AP or STA may suspend an SAR limit (for example, a transmission power threshold associated with the SAR limit) such that the AP or STA may increase a transmission power of a control frame.

### CROSS REFERENCE

The present Application is a 371 national phase filing of International PCT Application No. PCT/CN2022/112671 by XU et al., entitled “WIRELESS LOCAL AREA NETWORK THROUGHPUT AND COVERAGE WITH ENHANCED SPECIFIC ABSORPTION RATE,” filed Aug. 16, 2022, which is assigned to the assignee hereof, and which is expressly incorporated by reference in its entirety herein.

### TECHNICAL FIELD

The following relates to wireless communications, including wireless local area network (WLAN) throughput and coverage with enhanced specific absorption rate (SAR).

### DESCRIPTION OF RELATED TECHNOLOGY

Wireless communications systems are widely deployed to provide various types of communication content such as voice, video, packet data, messaging, broadcast, and so on. These systems may be multiple-access systems capable of supporting communication with multiple users by sharing the available system resources (for example, time, frequency, and power). A wireless network, for example a WLAN, such as a Wi-Fi (for example, Institute of Electrical and Electronics Engineers (IEEE) 802.11) network may include an access point (AP) that may communicate with one or more stations (STAs) or mobile devices. The AP may be coupled to a network, such as the Internet, and may enable a mobile device to communicate via the network (or communicate with other devices coupled to the AP). A wireless device may communicate with a network device bi-directionally. For example, in a WLAN, a STA may communicate with an associated AP via downlink (DL) and uplink (UL) directions. The DL (or forward link) may refer to the communication link from the AP to the station, and the UL (or reverse link) may refer to the communication link from the station to the AP.

An AP and a STA may communicate in accordance with a specific absorption rate (SAR) limit. For example, the AP or the STA may determine a transmission power of a frame such that the SAR limit is not exceeded. Accordingly, the transmission power of the frame may be limited by the SAR limit. In some cases, such as in low signal strength scenarios, however, the AP or the STA may be configured to increase a transmission power of a frame, for example, to increase a signal strength of the frame. However, the AP or the STA may be constrained from increasing the transmission power due to the SAR limit, which may result in reduced throughput and communication range between the AP and the STA, among other issues.

### SUMMARY

The systems, methods and devices of this disclosure each have several innovative aspects, no single one of which is solely responsible for the desirable attributes disclosed herein.

One innovative aspect of the subject matter described in this disclosure can be implemented in an apparatus for wireless communication at a first wireless device. The apparatus may include a processor and memory coupled with the processor and storing instructions. The instructions may be executable by the processor to cause the apparatus to receive a reference signal associated with measurement of a signal strength between the first wireless device and a second wireless device, determine that a specific absorption rate limit associated with communication between the first wireless device and the second wireless device and for a first time interval is less than a threshold, modify the specific absorption rate limit for the first time interval based at least in part on the signal strength failing to satisfy a signal strength threshold and the specific absorption rate limit for the first time interval being less than the threshold, and transmit, during the first time interval, a data frame having a transmission power that is based at least in part on the modified specific absorption rate limit for the first time interval.

Another innovative aspect of the subject matter described in this disclosure can be implemented in a method for wireless communication by or at a first wireless device. The method may include receiving a reference signal associated with measuring a signal strength between the first wireless device and a second wireless device, determining that a specific absorption rate limit associated with communication between the first wireless device and the second wireless device and for a first time interval is less than a threshold, modifying the specific absorption rate limit for the first time interval based at least in part on the signal strength failing to satisfy a signal strength threshold and the specific absorption rate limit for the first time interval being less than the threshold, and transmitting, during the first time interval, a data frame having a transmission power that is based at least in part on the modified specific absorption rate limit for the first time interval.

Another innovative aspect of the subject matter described in this disclosure can be implemented in first wireless device. The first wireless device may include means for receiving a reference signal associated with measuring a signal strength between the first wireless device and a second wireless device, means for determining that a specific absorption rate limit associated with communication between the first wireless device and the second wireless device and for a first time interval is less than a threshold, means for modifying the specific absorption rate limit for the first time interval based at least in part on the signal strength failing to satisfy a signal strength threshold and the specific absorption rate limit for the first time interval being less than the threshold, and means for transmitting, during the first time interval, a data frame having a transmission power that is based at least in part on the modified specific absorption rate limit for the first time interval.

Another innovative aspect of the subject matter described in this disclosure can be implemented in a non-transitory computer-readable medium storing code for wireless communication by or at a first wireless device. The code may include instructions executable by a processor to cause the first wireless device to receive a reference signal associated with measurement of a signal strength between the first wireless device and a second wireless device, determine that a specific absorption rate limit associated with communication between the first wireless device and the second wireless device and for a first time interval is less than a threshold, modify the specific absorption rate limit for the first time interval based at least in part on the signal strength failing to satisfy a signal strength threshold and the specific absorption rate limit for the first time interval being less than the threshold, and transmit, during the first time interval, a data frame having a transmission power that is based at least in part on the modified specific absorption rate limit for the first time interval.

Some implementations of the method, apparatus, first wireless devices, and non-transitory computer-readable medium described herein may further include operations, features, means, or instructions for modifying a duty cycle associated with the first time interval based at least in part on modifying the specific absorption rate limit for the first time interval, where the data frame is transmitted in accordance with the modified duty cycle.

In some implementations of the method, apparatus first wireless devices, and non-transitory computer-readable medium described herein, modifying the specific absorption rate limit for the first time interval includes setting the specific absorption rate limit for the first time interval equal to the threshold.

In some implementations of the method, apparatus, first wireless devices, and non-transitory computer-readable medium described herein, the transmission power of the data frame is greater than a transmission power threshold associated with the unmodified specific absorption rate limit.

In some implementations of the method, apparatus, first wireless devices, and non-transitory computer-readable medium described herein, the first wireless device is an access point and the second wireless device is a station.

Another innovative aspect of the subject matter described in this disclosure can be implemented in an apparatus for wireless communication at a first wireless device. The apparatus may include a processor and memory coupled with the processor and storing instructions. The instructions may be executable by the processor to cause the apparatus to schedule a transmission of a control frame to a second wireless device, suspend, based at least in part on the scheduling, a transmission power threshold associated with a specific absorption rate limit for communications between the first wireless device and the second wireless device, and transmit, to the second wireless device, the control frame having a transmission power that is greater than the transmission power threshold based at least in part on suspending the transmission power threshold.

Another innovative aspect of the subject matter described in this disclosure can be implemented in a method for wireless communication by or at a first wireless device. The method may include scheduling a transmission of a control frame to a second wireless device, suspending, based at least in part on the scheduling, a transmission power threshold associated with a specific absorption rate limit for communications between the first wireless device and the second wireless device, and transmitting, to the second wireless device, the control frame having a transmission power that is greater than the transmission power threshold based at least in part on suspending the transmission power threshold.

Another innovative aspect of the subject matter described in this disclosure can be implemented in a first wireless device. The first wireless device may include means for scheduling a transmission of a control frame to a second wireless device, means for suspending, based at least in part on the scheduling, a transmission power threshold associated with a specific absorption rate limit for communications between the first wireless device and the second wireless device, and means for transmitting, to the second wireless device, the control frame having a transmission power that is greater than the transmission power threshold based at least in part on suspending the transmission power threshold.

Another innovative aspect of the subject matter described in this disclosure can be implemented in a non-transitory computer-readable medium storing code for wireless communication by or at a first wireless device. The code may include instructions executable by a processor to cause the first wireless device to schedule a transmission of a control frame to a second wireless device, suspend, based at least in part on the scheduling, a transmission power threshold associated with a specific absorption rate limit for communications between the first wireless device and the second wireless device, and transmit, to the second wireless device, the control frame having a transmission power that is greater than the transmission power threshold based at least in part on suspending the transmission power threshold.

Some implementations of the method, apparatus, first wireless devices, and non-transitory computer-readable medium described herein may further include operations, features, means, or instructions for determining, based at least in part on suspending the transmission power threshold, the transmission power of the control frame in accordance with a transmission power limit associated with a channel via which the control frame is transmitted, a hardware capability of the first wireless device, or a combination thereof.

Some implementations of the method, apparatus, first wireless devices, and non-transitory computer-readable medium described herein may further include operations, features, means, or instructions for scheduling a transmission of a data frame to the second wireless device, reinstating, based at least in part on the scheduling of the data frame, the transmission power threshold, and transmitting, to the second wireless device, the data frame having a second transmission power that is in accordance with the transmission power threshold based at least in part on reinstating the transmission power threshold.

In some implementations of the method, apparatus, first wireless devices, and non-transitory computer-readable medium described herein, the transmission power threshold is suspended based at least in part on a duration of the control frame being less than a threshold duration.

In some implementations of the method, apparatus, first wireless devices, and non-transitory computer-readable medium described herein, the first wireless device is a station and the second wireless device is an access point.

In some implementations of the method, apparatus, first wireless devices, and non-transitory computer-readable medium described herein, the first wireless device is an access point and the second wireless device is a station.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIGS. 1-5 each illustrate an example of a wireless local area network (WLAN) that supports WLAN throughput and coverage with enhanced specific absorption rate (SAR) in accordance with aspects of the present disclosure.

FIGS. 6 and 7 show block diagrams of devices that support WLAN throughput and coverage with enhanced SAR in accordance with one or more aspects of the present disclosure.

FIG. 8 shows a block diagram of a communications manager that supports WLAN throughput and coverage with enhanced SAR in accordance with one or more aspects of the present disclosure.

FIG. 9 shows a diagram of a system including a device that supports WLAN throughput and coverage with enhanced SAR in accordance with one or more aspects of the present disclosure.

FIGS. 10 through 15 show flowcharts illustrating methods that support WLAN throughput and coverage with enhanced SAR in accordance with one or more aspects of the present disclosure.

### DETAILED DESCRIPTION

A wireless local area network (WLAN) may support the communication of frames, such as control frames (for example, messages including control information) and data frames (for example, messages including data), between an access point (AP) and a station (STA). In some cases, a transmission power of a given frame may be limited based on a specific absorption rate (SAR) limit, where the SAR may refer to a measure of the rate that radio frequency energy is absorbed, for example, by the human body. That is, the AP or the STA may limit the transmission power of a given frame to avoid exceeding the SAR limit. In some cases, however, such transmission power limitation may reduce throughput and a coverage area of the WLAN. For example, if a received signal strength indicator (RSSI) associated with communication between the AP and the STA is relatively low (for example, below a threshold), the AP or the STA may increase the transmission power of the frame, for example, to increase the signal strength between the AP and the STA. However, in some cases, the AP or the STA may be unable to (for example, refrain from, be constrained from) increase the transmission power due to the SAR limit. For example, if increasing the transmission power would cause the SAR limit to be exceeded, the AP or the STA may not increase the transmission power regardless of the signal strength between the AP and the STA. Additionally, in some cases, throughput may decrease as signal strength (for example, RSSI measurement) decreases, and the signal strength may decrease as the STA approaches an edge of a coverage area of the AP. Accordingly, throughput and coverage may be limited based on a transmission power limit associated with the SAR limit.

Various aspects generally relate to suspending or modifying SAR limits to support increased frame transmission power, and more specifically to leveraging the implementation of a time-averaged SAR limit to support such transmission power increase. For example, a time-averaged SAR may refer to a SAR over a duration. Thus, even if an SAR limit is exceeded at various instances during the duration, an average transmission power over the duration may satisfy the SAR limit (for example, because transmission powers at other instances during the duration may be less than the SAR limit). In some examples, the AP or the STA may suspend the SAR limit for transmission of a control frame. For example, the control frame may have a relatively short duration (for example, compared to a duration of a data frame). The SAR limit (for example, a transmission power threshold associated with the SAR limit) may be removed in determining a transmission power of the control frame because, from the time average point of view, the SAR limit may still be satisfied. In some examples, the AP or the STA may “borrow” transmission power from a duty cycle associated with communication between the AP and the STA to temporarily modify (for example, increase) the SAR limit associated with transmission of the data frame. For example, data frames may have relatively longer durations such that transmitting the data frame with a transmission power exceeding the SAR limit may risk exceeding a time-averaged SAR limit. To support increasing the SAR limit for a data frame, the AP or the STA may reduce a duty cycle of a communication cycle (among other aspects) such that fewer signals are communicated (for example, scheduled) during the communication cycle. As such, the SAR limit may be increased, thereby supporting a transmission power of the data frame to be increased while the time-averaged SAR limit is satisfied.

Particular aspects of the subject matter described in this disclosure may be implemented to realize one or more of the following potential advantages. The techniques employed by the described communication devices (for example, APs, STAs) may provide benefits and enhancements, including increased throughput, communication reliability, and WLAN coverage, among other benefits. For example, temporarily suspending or modifying an SAR limit (for example, transmission power thresholds associated with the SAR limit) will enable a communication device to increase a transmission power of a frame relative to if the SAR limit were enforced while satisfying a time average SAR limit (for example, by reducing a duty cycle for transmission of a data frame). Increasing the transmission power will increase a signal strength of the frame, which will result in increased communication reliability and increased throughput. Additionally, increasing the transmission will increase a coverage area, for example, of an AP, by supporting increased distances at which the AP and a STA may communicate.

Aspects of the disclosure are initially described in the context of WLANs. Aspects of the disclosure are further illustrated by and described with reference to apparatus diagrams, system diagrams, and flowcharts that relate to WLAN throughput and coverage with enhanced SAR.

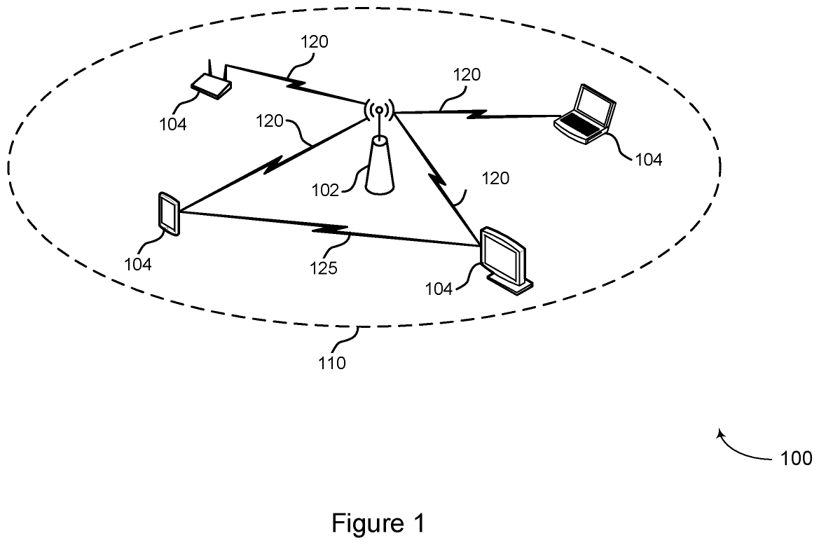

FIG. 1 illustrates a WLAN 100 (also known as a Wi-Fi network) configured in accordance with various aspects of the present disclosure. The WLAN 100 may include an AP 102 and multiple associated STAs 104, which may represent devices such as mobile stations, personal digital assistant (PDAs), other handheld devices, netbooks, notebook computers, tablet computers, laptops, display devices (for example, TVs, computer monitors, etc.), printers, etc. The AP 102 and the associated STAs 104 may represent a basic service set (BSS) or an extended service set (ESS) (for example, a set of connected BSSs). The various STAs 104 in the network are able to communicate with one another through the AP 102. Also shown is a coverage area 110 of the AP 102, which may represent a basic service area (BSA) of the WLAN 100. An extended network station (not shown) associated with the WLAN 100 may be connected to a wired or wireless distribution system that may allow multiple APs 102 to be connected in an ESS.

In the WLAN 100, the AP 102 and a STA 104 may communicate control frames and data frames. In some cases, the AP 102 and the STA 104 may communicate frames having transmission powers such that one or more limitations may be satisfied. For example, in some cases, the AP 102 and the STA 104 may communicate a frame having a transmission power such that an SAR limit (for example, an instantaneous SAR limit) may be satisfied. That is, the transmission power of the frame may be such that the SAR limit is not exceeded. Additionally or alternatively, the AP 102 and the STA 104 may communicate one or more frames over a duration of time and having transmission powers such that a time-averaged SAR limit may be satisfied.

In accordance with examples described herein, an AP 102, a STA 104 or both, may be configured to suspend or modify an SAR limit (for example, a transmission power threshold associated with SAR limit) such that a frame (for example, a control frame, a data frame) may be transmitted with an increased transmission power relative to if the SAR limit were unmodified or enforced. In some examples, a duty cycle associated with a data frame may be modified (for example, reduced) such that a time-averaged SAR limit may be satisfied while supporting the transmission of data frames with increased transmission power. Communicating frames having increased transmission powers may support increased WLAN coverage, increased throughput, increased communication reliability, and increased data rates, among other benefits.

Although not shown in FIG. 1, a STA 104 may be located in the intersection of more than one coverage area 110 and may associate with more than one AP 102. A single AP 102 and an associated set of STAs 104 may be referred to as a BSS. An ESS is a set of connected BSSs. A distribution system (not shown) may be used to connect APs 102 in an ESS. In some cases, the coverage area 110 of an AP 102 may be divided into sectors (also not shown). The WLAN 100 may include APs 102 of different types (for example, metropolitan area, home network, etc.), with varying and overlapping coverage areas 110.

Each of the STAs 104 may associate and communicate with the AP 102 via a communication link 120. The various STAs 104 in the WLAN 100 may be able to communicate with one another through the AP 102. STAs 104 may function and communicate (via the respective communication links 120) according to the IEEE 802.11 family of standards and amendments including, but not limited to, 802.11a, 802.11b, 802.11g, 802.11n, 802.11ac, 802.11ad, 802.11ah, 802.11ay, 802.11ax, 802.11az, and 802.11ba. These standards define the WLAN radio and baseband protocols for the PHY and medium access control (MAC) layers. The wireless devices in the WLAN 100 may communicate over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. The unlicensed spectrum may also include other frequency bands, such as the emerging 6 GHz band. The wireless devices in the WLAN 100 may also be configured to communicate over other frequency bands such as shared licensed frequency bands, where multiple operators may have a license to operate in the same or overlapping frequency band or bands.

Two STAs 104 may also communicate directly via a direct wireless link 125 regardless of whether both STAs 104 are in the same coverage area 110. Examples of direct wireless links 125 may include Wi-Fi Direct connections, Wi-Fi Tunneled Direct Link Setup (TDLS) links, and other group connections. STAs 104 and APs 102 may communicate according to the WLAN radio and baseband protocol for physical and MAC layers from IEEE 802.11 and versions including, but not limited to, 802.11b, 802.11g, 802.11a, 802.11n, 802.11ac, 802.11ad, 802.11ah, 802.11ax, etc. In other implementations, peer-to-peer connections or ad hoc networks may be implemented within WLAN 100.

In some cases, a STA 104 (or an AP 102) may be detectable by a central AP 102, but not by other STAs 104 in the coverage area 110 of the central AP 102. For example, one STA 104 may be at one end of the coverage area 110 of the central AP 102 while another STA 104 may be at the other end. Thus, both STAs 104 may communicate with the AP 102, but may not receive the transmissions of the other. This may result in colliding transmissions for the two STAs 104 in a contention based environment (for example, CSMA/CA) because the STAs 104 may not refrain from transmitting on top of each other. A STA 104 whose transmissions are not identifiable, but that is within the same coverage area 110 may be known as a hidden node. CSMA/CA may be supplemented by the exchange of an RTS packet transmitted by a sending STA 104 (or AP 102) and a CTS packet transmitted by the receiving STA 104 (or AP 102). This may alert other devices within range of the sender and receiver not to transmit for the duration of the primary transmission. Thus, RTS/CTS may help mitigate a hidden node problem.

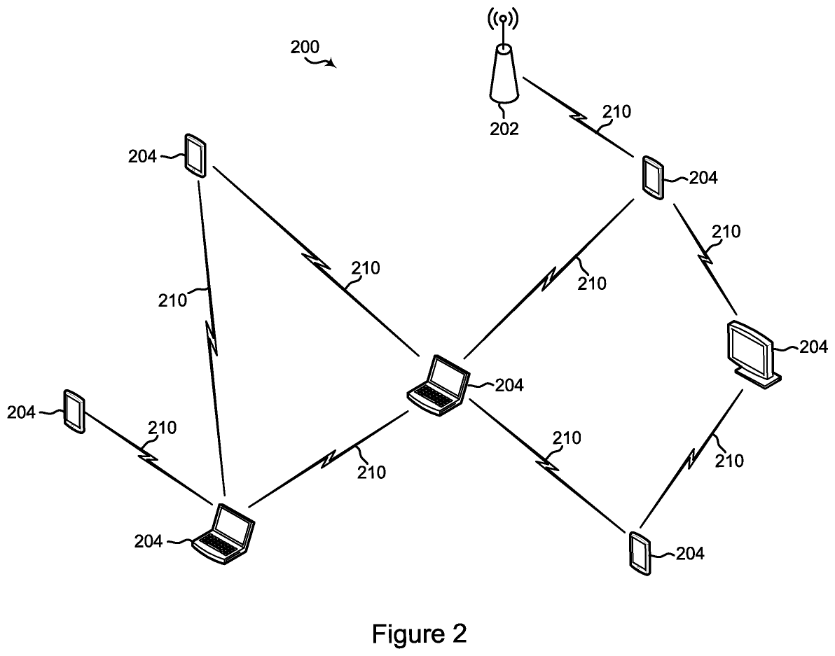

FIG. 2 illustrates an example of a WLAN 200 that supports WLAN throughput and coverage with enhanced SAR in accordance with one or more aspects of the present disclosure. According to some aspects, the WLAN 200 can be an example of a WLAN. For example, the WLAN 200 can be a network implementing at least one of the IEEE 802.11 family of standards. The WLAN 200 may include multiple STAs 204. As described above, each of the STAs 204 also may be referred to as a mobile station (MS), a mobile device, a mobile handset, a wireless handset, an access terminal (AT), a user equipment (UE), a subscriber station (SS), or a subscriber unit, among other possibilities. The STAs 204 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other possibilities.

The WLAN 200 is an example of a peer-to-peer (P2P), ad hoc or mesh network. STAs 204 can communicate directly with each other via P2P wireless links 210 (without the use of an intermediary AP). In some implementations, the WLAN 200 is an example of a neighbor awareness network (NAN). NANs operate in accordance with the Wi-Fi Alliance (WFA) Neighbor Awareness Networking (also referred to as NAN) standard specification. NAN-compliant STAs 204 (hereinafter also simply “NAN devices 204”) transmit and receive NAN communications (for example, in the form of Wi-Fi packets including frames conforming to an IEEE 802.11 wireless communication protocol standard such as that defined by the IEEE 802.11-2016 specification or amendments thereof including, but not limited to, 802.11ay, 802.11ax, 802.11az, 802.11ba and 802.11be) to and from one another via wireless P2P links 210 (hereinafter also referred to as “NAN links”) using a data packet routing protocol, such as Hybrid Wireless Mesh Protocol (HWMP), for path selection.

A NAN network generally refers to a collection of NAN devices that share a common set of NAN parameters including: the time period between consecutive discovery windows, the time duration of the discovery windows, the NAN beacon interval, and the NAN discovery channel(s). A NAN ID is an identifier signifying a specific set of NAN parameters for use within the NAN network. NAN networks are dynamically self-organized and self-configured. NAN devices 204 in the network automatically establish an ad-hoc network with other NAN devices 204 such that network connectivity can be maintained. Each NAN device 204 is configured to relay data for the NAN network such that various NAN devices 204 may cooperate in the distribution of data within the network. As a result, a message can be transmitted from a source NAN device to a destination NAN device by being propagated along a path, hopping from one NAN device to the next until the destination is reached.

Each NAN device 204 is configured to transmit two types of beacons: NAN discovery beacons and NAN synchronization beacons. When a NAN device 204 is turned on, or otherwise when NAN-functionality is enabled, the NAN device periodically transmits NAN discovery beacons (for example, every 100 TUs, every 128 TUs or another suitable period) and NAN synchronization beacons (for example, every 512 TUs or another suitable period). Discovery beacons are management frames, transmitted between discovery windows, used to facilitate the discovery of NAN clusters. A NAN cluster is a collection of NAN devices within a NAN network that are synchronized to the same clock and discovery window schedule using a time synchronization function (TSF). To join NAN clusters, NAN devices 204 passively scan for discovery beacons from other NAN devices. When two NAN devices 204 come within a transmission range of one another, they will discover each other based on such discovery beacons. Respective master preference values determine which of the NAN devices 204 will become the master device. If a NAN cluster is not discovered, a NAN device 204 may start a new NAN cluster. When a NAN device 204 starts a NAN cluster, it assumes the master role and broadcasts a discovery beacon. Additionally, a NAN device may choose to participate in more than one NAN cluster within a NAN network.

The links between the NAN devices 204 in a NAN cluster are associated with discovery windows—the times and channel on which the NAN devices converge. At the beginning of each discovery window, one or more NAN devices 204 may transmit a NAN synchronization beacon, which is a management frame used to synchronize the timing of the NAN devices within the NAN cluster to that of the master device. The NAN devices 204 may then transmit multicast or unicast NAN service discovery frames directly to other NAN devices within the service discovery threshold and in the same NAN cluster during the discovery window. The service discovery frames indicate services supported by the respective NAN devices 204.

In some instances, NAN devices 204 may exchange service discovery frames to ascertain whether both devices support ranging operations. NAN devices 204 may perform such ranging operations (“ranging”) during the discovery windows. The ranging may involve an exchange of fine timing measurement (FTM) frames (such as those defined in IEEE 802.11-REVmc). For example, a first NAN device 204 may transmit unicast FTM requests to multiple peer NAN devices 204. The peer NAN devices 204 may then transmit responses to the first NAN device 204. The first NAN device 204 may then exchange a number of FTM frames with each of the peer NAN devices 204. The first NAN device 204 may then determine a range between itself and each of the peer devices 204 based on the FTM frames and transmit a range indication to each of the peer NAN devices 204. For example, the range indication may include a distance value or an indication as to whether a peer NAN device 204 is within a service discovery threshold (for example, 3 meters(m)) of the first NAN device 204. NAN links between NAN devices within the same NAN cluster may persist over multiple discovery windows as long as the NAN devices remain within the service discovery thresholds of one another and synchronized to the anchor master of the NAN cluster.

Some NAN devices 204 also may be configured for wireless communication with other networks such as with a Wi-Fi WLAN or a wireless (for example, cellular) wide area network (WWAN), which may, in turn, provide access to external networks including the Internet. For example, a NAN device 204 may be configured to associate and communicate, via a Wi-Fi or cellular link 212, with an AP or base station 202 of a WLAN or WWAN network, respectively. In such instances, the NAN device 204 may include SoftAP functionality enabling the STA to operate as a Wi-Fi hotspot to provide other NAN devices 204 with access to the external networks via the associated WLAN or WWAN backhaul. Such a NAN device 204 (referred to as a NAN concurrent device) is capable of operating in both a NAN network as well as another type of wireless network, such as a Wi-Fi BSS. In some such implementations, a NAN device 204 may, in a service discovery frame, advertise an ability to provide such AP services to other NAN devices 204.

There are two general NAN service discovery messages: publish messages and subscribe messages. Generally, publishing is a mechanism for an application on a NAN device to make selected information about the capabilities and services of the NAN device available to other NAN devices, while subscribing is a mechanism for an application on a NAN device to gather selected types of information about the capabilities and services of other NAN devices. A NAN device may generate and transmit a subscribe message when requesting other NAN devices operating within the same NAN cluster to provide a specific service. For example, in an active subscriber mode, a subscribe function executing within the NAN device may transmit a NAN service discovery frame to actively seek the availability of specific services. A publish function executing within a publishing NAN device capable of providing a requested service may, for example, transmit a publish message to reply to the subscribing NAN device responsive to the satisfaction of criteria specified in the subscribe message. The publish message may include a range parameter indicating the service discovery threshold, which represents the maximum distance at which a subscribing NAN device can avail itself of the services of the publishing NAN device. A NAN also may use a publish message in an unsolicited manner, for example, a publishing NAN device may generate and transmit a publish message to make its services discoverable for other NAN devices operating within the same NAN cluster. In a passive subscriber mode, the subscribe function does not initiate the transfer of any subscribe message, rather, the subscribe function looks for matches in received publish messages to determine the availability of desired services.

Subsequent to a discovery window is a transmission opportunity period. This period includes numerous resource blocks. A NAN device link (NDL) refers to the negotiated resource blocks between NAN devices used for NAN operations. An NDL can include more than one “hop.” The number of hops depends on the number of devices between the device providing the service and the device consuming or subscribing to the service. An example of an NDL that includes two hops includes three NAN devices: the provider, the subscriber and a proxy to relay the information between the provider and the subscriber. In such a configuration, the first hop refers to the communication of information between the provider and the proxy, and the second hop refers to the communication of the information between the proxy and the subscriber. An NDL may refer to a subset of NAN devices capable of one-hop service discovery, but an NDL also may be capable of service discovery and subscription over multiple hops (a multi-hop NDL).

There are two general NDL types: paged NDL (P-NDL) and synchronized NDL (S-NDL). Each common resource block (CRB) of a P-NDL includes a paging window (PW) followed by a transmission window (TxW). All NAN devices participating in a P-NDL operate in a state to receive frames during the paging window. Generally, the participating NAN devices wake up during the paging window to listen on the paging channel to determine whether there is any traffic buffered for the respective devices. For example, a NAN device that has pending data for transmission to another NAN device may transmit a traffic announcement message to the other NAN device during the paging window to inform the other NAN device of the buffered data. If there is data available, the NAN device remains awake during the transmission window to exchange the data. If there is no data to send, the NAN device may transition back to a sleep state during the transmission window to conserve power. A NAN device transmits a paging message to its NDL peer during a paging window if it has buffered data available for the peer. The paging message includes, for example, the MAC addresses or identifiers of the destination devices for which data is available. A NAN device that is listed as a recipient in a received paging message transmits a trigger frame to the transmitting device and remains awake during the subsequent transmission window to receive the data. The NDL transmitter device transmits the buffered data during the transmission window to the recipient devices from whom it received a trigger frame. A NAN device that establishes an S-NDL with a peer NAN device may transmit data frames to the peer from the beginning of each S-NDL CRB without transmitting a paging message in advance.

In accordance with examples described herein, a NAN device 204, an AP 202, or both, may be configured to suspend or modify an SAR limit (for example, a transmission power threshold associated with the SAR limit) such that a frame may be transmitted with an increased transmission power relative to if the SAR limit were enforced. In some examples, a duty cycle associated with a data frame may be modified (for example, reduced) such that time-averaged SAR limits may be satisfied while supporting the transmission of data frames with increased transmission power.

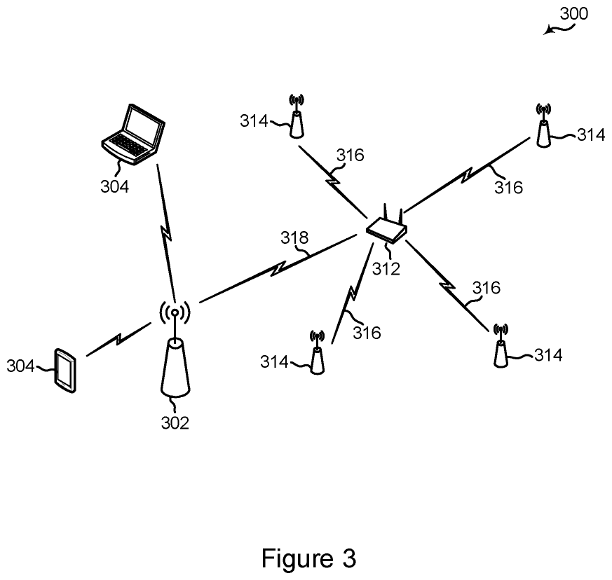

FIG. 3 illustrates an example of a WLAN 300 that supports WLAN throughput and coverage with enhanced SAR in accordance with one or more aspects of the present disclosure. According to some aspects, the WLAN 300 can be an example of a mesh network, an IoT network or a sensor network. The WLAN 300 may include multiple wireless communication devices 314. The wireless communication devices 314 may represent various devices such as display devices (for example, TVs, computer monitors, navigation systems, among others), music or other audio or stereo devices, remote control devices (“remotes”), printers, kitchen or other household appliances, among other possibilities.

In some implementations, the wireless communication devices 314 sense, measure, collect or otherwise obtain and process data and then transmit such raw or processed data to an intermediate device 312 for subsequent processing or distribution. Additionally or alternatively, the intermediate device 312 may transmit control information, digital content (for example, audio or video data), configuration information or other instructions to the wireless communication devices 314. The intermediate device 312 and the wireless communication devices 314 can communicate with one another via wireless links 316. In some implementations, the wireless links 316 include Bluetooth links or other PAN or short-range communication links.

In some examples, the intermediate device 312 also may be configured for wireless communication with other networks such as with a Wi-Fi WLAN or a wireless (for example, cellular) wide area network (WWAN), which may, in turn, provide access to external networks including the Internet. For example, the intermediate device 312 may be configured to associate and communicate, over a Wi-Fi link 318, with an AP 302 of a WLAN network, which also may serve various STAs 304. In some implementations, the intermediate device 312 is an example of a network gateway, for example, an IoT gateway. In such a manner, the intermediate device 312 may serve as an edge network bridge providing a Wi-Fi core backhaul for the IoT network including the wireless communication devices 314. In some implementations, the intermediate device 312 can be configured to analyze, preprocess and aggregate data received from the wireless communication devices 314 locally at the edge before transmitting it to other devices or external networks via the Wi-Fi link 318. The intermediate device 312 also can be configured to provide additional security for the IoT network and the data it transports.

In accordance with examples described herein, an AP 302, a STA 304, an intermediate device 312, or a wireless communication device 314 may be configured to suspend or modify an SAR limit (for example, a transmission power threshold associated with SAR limit) such that a may be transmitted with an increased transmission power relative to if the SAR limit were enforced. In some examples, a duty cycle associated with a data frame may be modified (for example, reduced) such that a time-averaged SAR limit may be satisfied while supporting the transmission of data frames with increased transmission power.

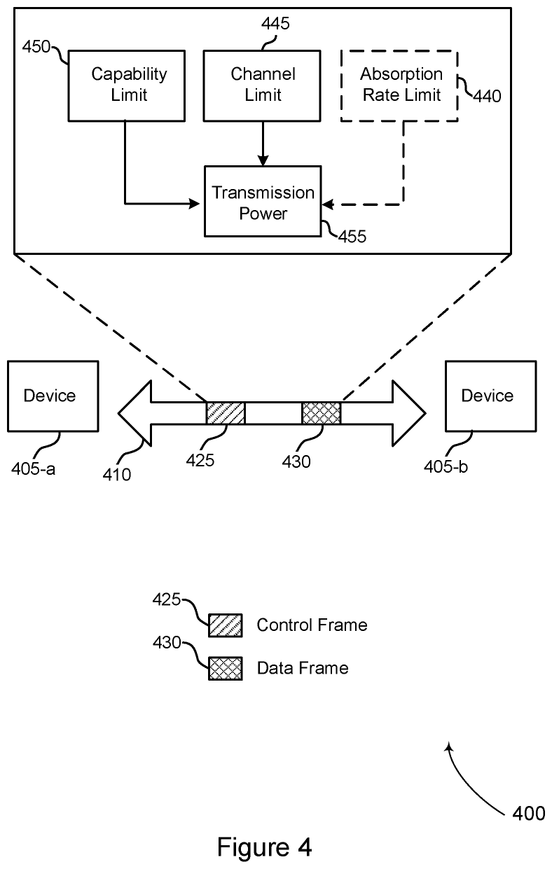

FIG. 4 illustrates an example of a WLAN 400 that supports WLAN throughput and coverage with enhanced SAR in accordance with one or more aspects of the present disclosure. In some aspects, the WLAN 400 may implement or be implemented by aspects of the WLANs 100, 200, and 300, as described herein, including with reference to FIGS. 1-3, respectively. For example, the WLAN 400 may include wireless communication devices, such as a device 405-a and a device 405-b. In some examples, the device 405-a may be an example of a STA described herein (for example, a STA 104, 204, 304) and the device 405-b may be an example of an AP described herein (for example, an AP 102, 202, 302). In some examples, the device 405-a may be an example of an AP, and the device 405-b may be an example of a STA.

The WLAN 400 may support communications between the device 405-a and the device 405-b. For example, the device 405-a and the device 405-b may communicate messages (for example, frames) via a communication link 410, which may be an example of a communication link described herein, such as a communication link 120, a direct wireless link 125, a P2P link 210, a wireless link 316, or a Wi-Fi link 318, among other types of communication links.

In some examples, the devices 405 may determine a transmission power 455 for a frame based in part on or in accordance with various transmission power limits. For example, the maximum transmission power 455 for a frame may correspond to a minimum of an absorption rate limit 440, a channel limit 445, a capability limit 450, or a combination thereof. The capability limit 450 may be associated with a hardware capability of a device 405. For example, the capability limit 450 may correspond to a transmission power that the hardware of the device 405 is capable of supporting. The channel limit 445 may be associated with a channel via which a frame is transmitted. For example, the devices 405 may communicate via various channels corresponding to various frequency bands. In some cases, communicated frames via one channel may cause interference at frames communicated via another channel. The channel limit 445 may correspond to a transmission power limit of the channel that is associated with reducing or mitigating interference with other channels. In some examples, the channel limit 445 may be referred to as a confirmatory test limit (CTL).

The absorption rate limit 440 may correspond to or be associated with an SAR limit. For example, the absorption rate limit 440 may correspond to a transmission power threshold (for example, a transmission power limit) associated with ensuring that the SAR limit is satisfied when communicating frames between the devices 405. That is, the absorption rate limit 440 may limit the transmission power 455 of a frame such that a SAR associated with the frame is less than (for example or equal to) the SAR limit. In some examples, absorption rate limit 440 may be associated with a time-averaged SAR limit. For example, a time-averaged SAR may refer to a SAR measured over a duration over time, for example, rather than an instantaneous SAR measurement. In some cases, a transmission power 455 of a frame may result in the SAR limit to be exceeded at multiple instances during the duration, however, the average transmission power over the duration may satisfy the SAR limit. That is, the devices 405 (for example, a device under test (DUT) transmitter) may comply with the SAR limit despite transmitting some frames having a transmission power 455 that would otherwise exceed the SAR limit. For example, the transmission power 455 at some other time instances may be below the SAR limit to compensate for (for example, counteract) the instances where the transmission power 455 causes the SAR limit to be exceeded.

In some cases, the duration of time associated with the time-averaged SAR limit may be a configured value (for example, a pre-configured vale, a standardized value, a defined value). For example, the duration may be configured as a 30 second time window such that an average SAR of communications transmitted by a device 405 over the time window satisfy the SAR limit. In some cases, a regulatory body, such as the United States Federal Communications Commission (FCC), among others, may define the duration of the time window for the time-averaged SAR limit. In some examples, the time window may be partitioned into sub-intervals of time (for example, by a device 405) to facilitate transmission power determination and compliance with the time-averaged SAR limit. For example, the absorption rate limit 440 may be determined (for example, calculated) for each sub-interval of the time window (for example, a 500 millisecond sub-interval of the 30 second time window, among other durations of sub-intervals) such that the time-averaged SAR limit may be satisfied over the time window. For instance, for a given sub-interval, a device 405 may determine an absorption rate limit 440 based on a cumulative transmission power thus far used by the device 405 during the time window, a remaining duration of the time window, or a combination thereof. The absorption rate limit 440 may be recalculated for each sub-interval.

In some cases, the absorption rate limit 440 may be less than the channel limit 445 and the capability limit 450. Here, the absorption rate limit 440 may be the limiting factor in determining a maximum transmission power 455 for a frame. For example, because the absorption rate limit 440 may be the minimum of the absorption rate limit 440, the channel limit 445, and the capability limit 450, the maximum transmission power 455 for a frame may correspond to a maximum transmission power allowed by the absorption rate limit 440. In some cases, however, such transmission power limitations may result in reduced throughput, reduced coverage of the WLAN 400, or both. For example, low RSSI regions of the WLAN 400 may be associated with reduced throughput or may be uncovered by the WLAN 400 (for example, communications in the low RSSI regions may be unsupported). Throughput may be increased and/or coverage may be extended by increasing a transmission power of a frame. However, in some cases, the transmission power may not be increased due to constraints associated with the absorption rate limit 440.

In accordance with examples described herein, the absorption rate limit 440 (for example, a transmission power threshold associated with the SAR limit) may be temporarily suspended (for example, removed) as a threshold for determining the transmission power 455 for a frame. For example, the device 405-a may schedule (for example, receive a message that schedules) transmission of a control frame 425 (for example, a management and control frame, a feedback frame such as an acknowledgement (ACK) frame) to the device 405-b. Based on scheduling the control frame 425, the device 405-a may suspend the absorption rate limit 440. For example, the device 405-a may be configured to suspend the absorption rate limit 440 in response to scheduling a control frame 425. In some examples, the device 405-a may be configured to suspend the absorption rate limit 440 for a control frame 425 based on a duration of the control frame 425 being less than a threshold duration. For instance, the duration of the control frame 425 may be relatively short, for example, compared to a duration of a data frame 430 or a duration of a sub-interval of the average time window. As such, a transmission power 455 of the control frame 425 may be increased with a relatively minimal effect on the average SAR. To support an increased transmission power 455 of the control frame 425, the device 405-a may suspend the absorption rate limit 440, thereby removing the absorption rate limit 440 from consideration as a threshold for determining the transmission power 455.

The device 405-a may determine the transmission power 455 for the control frame 425 based on suspending the absorption rate limit 440 and transmit the control frame 425 having the transmission power 455 to the device 405-b. The transmission power 455 may be greater than the absorption rate limit 440 based on the suspension. For example, due to the suspension of the absorption rate limit 440, the maximum transmission power 455 of the control frame 425 may instead be based on (for example, limited by) the capability limit 450 and the channel limit 445. In some examples, the capability limit 450 and the channel limit 445 may be greater than the absorption rate limit 440, and thus a maximum possible transmission power 455 of the control frame 425 based on the capability limit 450 and the channel limit 445 may be greater than a maximum possible transmission power 455 of the control frame 425 the control frame 425 if the absorption rate limit 440 was implemented (for example, enforced). As such, the device 405-a may determine the transmission power 455 in accordance with the capability limit 450 and the channel limit 445. In some examples, the transmission power 455 may be equal to a minimum of the capability limit 450 and the channel limit 445.

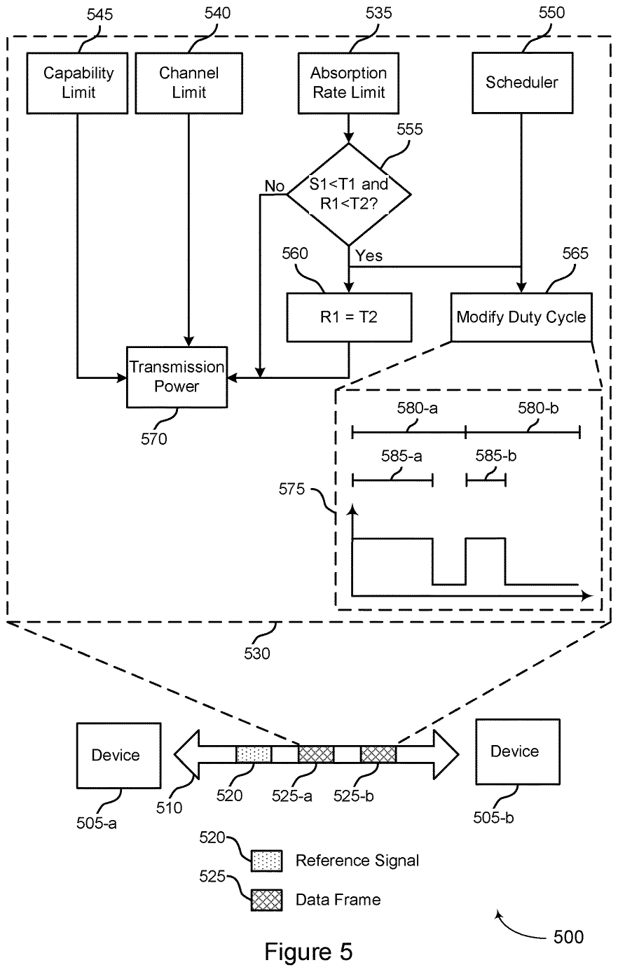

In some examples, the device 405-a may reinstate the absorption rate limit 440 as a threshold for determining the transmission power 455 for transmission of a data frame 430. For example, the device 405-a may schedule a transmission of the data frame 430 to the device 405-b. The device 405-a may be configured to enforce the absorption rate limit 440 for transmission of a data frame 430, for example, based on a duration of the data frame 430 failing to satisfy (for example, meeting or exceeding) a threshold duration. Based on scheduling the data frame 430, the device 405-a may reinstate the absorption rate limit 440. As such, the thresholds for determining the transmission power 455 of the data frame 430 may include the capability limit 450, the channel limit 445, and the absorption rate limit 440. The device 405-a may transmit the data frame 430 having a transmission power 455 determined in accordance with the enforced limits. In some examples, the device 405-a may be configured to modify the absorption rate limit 440 in determining the transmission power 455 for the data frame 430, for example, based on an RSSI, such that the transmission power 455 of the data frame 430 may be increased. Additional details related to modifying the absorption rate limit 440 for transmitting a data frame 430 are described below with reference to FIG. 5.

By temporarily suspending or modifying the absorption rate limit 440, the devices 405 may support increasing a transmission power 455 for communicating frames, which may increase a throughput, communication reliability, and coverage area of the WLAN 400 (for example, an AP in the WLAN 400), among other benefits, for example, by increasing a signal strength associated with the frames.

FIG. 5 illustrates an example of a WLAN 500 that supports WLAN throughput and coverage with enhanced SAR in accordance with one or more aspects of the present disclosure. In some aspects, the WLAN 500 may implement or be implemented by aspects of the WLANs 100, 200, 300, and 400, as described herein, including with reference to FIGS. 1-4, respectively. For example, the WLAN 500 may include wireless communication devices, such as a device 505-a and a device 505-b. In some examples, the device 505-a may be an example of a STA described herein and the device 505-b may be an example of an AP described herein. In some examples, the device 405-a may be an example of an AP, and the device 405-b may be an example of a STA.

The WLAN 500 may support communications between the device 505-a and the device 505-b. For example, the device 505-a and the device 505-b may communicate messages (for example, frames) via a communication link 510, which may be an example of a communication link described herein.

The devices 505 may communicate data, for example, via data frames 525. The device 505 may be configured to determine a transmission power 570 for a data frame 525 in accordance with various limits, such as a capability limit 545, a channel limit 540, and an absorption rate limit 535, which may be examples of a capability limit 450, a channel limit 445, and an absorption rate limit 440, respectively, described with reference to FIG. 4. In some examples, the absorption rate limit 535 may be less than the capability limit 545 and the channel limit 540 and may thus be the limiting factor in determining the transmission power 570 for the data frame 525. For example, a maximum transmission power for the data frame 525 may correspond to the absorption rate limit 535. In some cases, however, such transmission power limitations may result in reduced throughput, reduced coverage of the WLAN 500, or both. To support increased transmission power, the absorption rate limit 535 may be suspended for the transmission of some types of frames (for example, control frames), however, temporarily suspending the absorption rate limit 535 for a data frame 525 may increase a risk of non-compliance with a time-averaged SAR limit or reduce the absorption rate limits 535 calculated for subsequent sub-intervals of an average time window associated with the time-averaged SAR limit. For example, if the absorption rate limit 535 is suspended, the transmission power 570 for the data frame 525 may be increased such that an absorption rate limit 535 calculated for subsequent sub-intervals may be reduced in order to comply with the time-averaged SAR limit, which may reduce a signal strength and transmission power 570 of data frames 525 scheduled during the subsequent sub-intervals.

In accordance with examples described herein, a device 505 may “borrow” transmission power from a duty cycle 585 associated with communication between the devices 505 to support modifying the absorption rate limit 535 such that a transmission power 570 for a data frame 525 may be increased. For example, a duty cycle 585 may correspond to a duration of time during an interval 580 during which, for example, the device 505-a may transmit signals to the device 505-b. In some examples, the interval 580 may correspond to a sub-interval of the average time window (for example, a time interval for which the absorption rate limit 535 applies). The device 505-a may be configured to reduce a duty cycle 585 such that the absorption rate limit 535 may be increased and applied for the interval 580. For example, reducing the duty cycle 585 may reduce the quantity of signals that the device 505-a may transmit during the interval 580 (for example, reduce the quantity of frames that may be scheduled during the interval 580). Thus, the device 505-a may increase a transmission power 570 of one or more frames that are able to be scheduled during the interval 580 without (for example, or minimally) affecting the average transmission power over the interval 580. Such duty cycle 585 reduction to support increased transmission power 570 may be referred to as borrowing transmission power from the duty cycle 585.

In some examples, the device 505-a may determine a transmission power 570 for a data frame 525 in accordance with a process flow 530. In the following description of the process flow 530, the operations may be performed in a different order than the order shown. Specific operations also may be left out of the process flow 530, or other operations may be added to the process flow 530. Further, although some operations or signaling may be shown to occur at different times for discussion purposes, these operations may actually occur at the same time.

At 555, the device 505-a may evaluate various thresholds to determine whether the absorption rate limit 535 for an interval 580 may be modified. For example, the device 505-a may receive, from the device 505-b, a reference signal 520 associated with measuring a signal strength S1 between the device 505-a and the device 505-b (for example, determining an RSSI). The device 505-a may determine (for example, calculate) an absorption rate limit R1 for the interval 580. To determine whether to modify the absorption rate limit 535, the device 505-a may determine whether the signal strength S1 and the absorption rate limit R1 satisfy corresponding thresholds. For example, the device 505-a may compare the signal strength S1 to a signal strength threshold T1 (for example, the RSSI to T1) and the absorption rate limit R1 to a rate threshold T2.

In some examples, the device 505-a may determine that one or more of the signal strength S1 and the absorption rate limit R1 satisfy the corresponding thresholds (for example, S1≥T1, R1≥T2, or both). Here, the device 505-a may refrain from modifying the absorption rate limit R1 and a duty cycle 585. For example, the signal strength S1 being greater than threshold T1 may indicate that increasing transmission power for a data frame 525 is unnecessary due to there being sufficient signal strength between the device 505. Additionally or alternatively, the threshold T2 may be set to support compliance with the time-averaged SAR limit for the average time window, adequate transmission power limits for subsequent intervals 580, or a combination thereof. The device 505-a may schedule transmission of a data frame 525 and transmit the data frame 525 to the device 505-b having a transmission power 570 determined in accordance with the unmodified absorption rate limit R1.

In some other examples, the device 505-a may determine that the signal strength threshold S1 and the absorption rate limit R1 fail to satisfy the corresponding thresholds (for example, S1<T1 and R1<T2). In such examples, the device 505-a may modify the absorption rate limit R1 and the duty cycle 585. For example, at 560, the device 505-a may increase the absorption rate limit R1. In some examples, to modify the absorption rate limit R1, the device 505-a may set the absorption rate limit R1=T2. Based on modifying the absorption rate limit R1, the device 505-a may increase a transmission power 570 of a data frame 525 relative to if the absorption rate limit R1 were unmodified. For example, increasing the absorption rate limit R1 may increase a maximum potential transmission power for the data frame 525 by raising the limit imposed by the absorption rate limit R1. Accordingly, the device 505-a may schedule transmission of a data frame 525 and transmit the data frame 525 to the device 505-b having a transmission power 570 determined in accordance with the modified absorption rate limit R1, the channel limit 540, and the capability limit 545. The transmission power 570 of the data frame 525 may be greater than the unmodified absorption rate limit R1 (for example, a transmission power threshold associated with the unmodified absorption rate limit R1) based on modifying the absorption rate limit R1.

The transmission power 570 of the data frame 525 may be increased via borrowing the transmission power from the duty cycle 585. For example, at 565, the device 505-a may reduce (for example, throttle) the duty cycle 585 to support compliance with the time-averaged SAR limit of the average time window (for example, a time interval that includes the interval 580). The device 505-a may reduce the duty cycle as depicted in a duty cycle diagram 575. For example, the duty cycle diagram 575 may illustrate respective waveforms of duty cycle 585, which may represent the amount of time of a corresponding interval 580 during which the device 505-a may transmit signals. The duty cycle diagram 575 illustrates an interval 580-a and an interval 580-b that are associated with a duty cycle 585-a and a duty cycle 585-b, respectively. The duty cycle 585-b may be less than the duty cycle 585-a, which may correspond to fewer signals being able to be scheduled and transmitted during the interval 580-b relative to the interval 580-a. In some examples, the device 505-a may modify the duty cycle 585 for the interval 580, for example, by reducing the duty cycle 585 from the duty cycle 585-a to the duty cycle 585-b.

The device 505-a may schedule (for example, using a scheduler 550) one or more data frames 525 for transmission to the device 505-b in accordance with the modified duty cycle 585 and the modified absorption rate limit R1. For example, the device 505-a may schedule one or more data frames 525 such that the duty cycle 585 may be met and may transmit the one or more data frames 525 in accordance with the modified absorption rate limit R1.

In some examples, the absorption rate limit 535 and duty cycle 585 may be iteratively modified, for example, until the threshold T1 is met. For example, the device 505-a may transmit a data frame 525-a during an interval 580-a in accordance with a modified duty cycle 585-a and a modified absorption rate limit R1 (for example, based on the signal strength S1 and the absorption rate limit R1 failing to satisfy the corresponding thresholds T1 and T2). During a subsequent interval 580 (for example, an interval 580-b), the device 505-a may receive a second reference signal 520 and measure a signal strength S2. The device 505-a may determine an absorption rate limit R2 for the interval 580-b and may determine whether the signal strength S2 and the absorption rate limit R2 satisfy corresponding thresholds. For example, the device 505-a may determine whether the signal strength S2 satisfies the threshold T1 and whether the absorption rate limit R2 satisfies a rate threshold T3, which may be greater than the rate threshold T2. For instance, the rate threshold T3 may be greater than T2 to support further increasing the absorption rate limit 535 relative to the increase during the interval 580-a such that the transmission power 570 may be further increased. For instance, if the threshold T1 and T3 fail to be satisfied, the device 505-a may set the absorption rate limit R2 to T3 and further reduce the duty cycle to a duty cycle 585-b to support the increased absorption rate limit R2. As such, the device 505-a may determine a transmission power 570 for a data frame 525-b during the interval 580-b that is greater than the transmission power 570 for the data frame 525-a, which may increase a likelihood that a signal strength of the data frame 525-b satisfies the threshold T1.

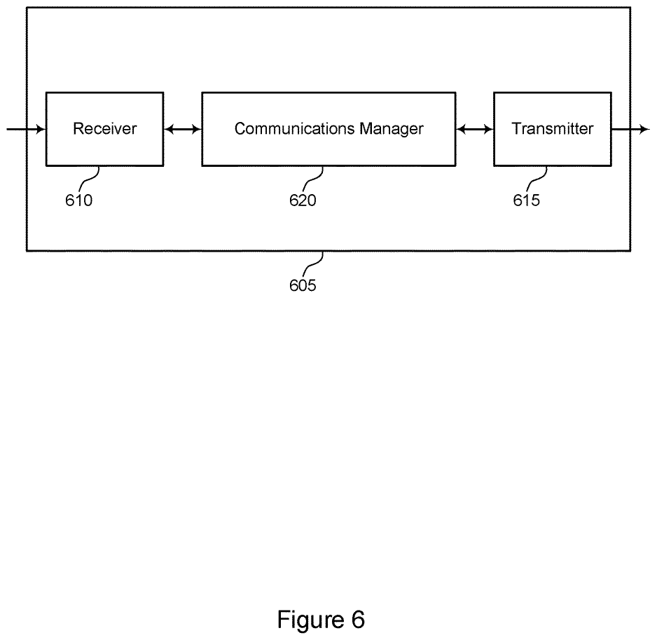

FIG. 6 shows a block diagram of a device 605 that supports WLAN throughput and coverage with enhanced SAR in accordance with one or more aspects of the present disclosure. The device 605 may be an example of aspects of an AP or a STA as described herein. The device 605 may include a receiver 610, a transmitter 615, and a communications manager 620. The communications manager 620 can be implemented, at least in part, by one or both of a modem and a processor. Each of these components may be in communication with one another (for example, via one or more buses).

The receiver 610 may provide a means for receiving information such as packets, user data, control information, or any combination thereof associated with various information channels (for example, control channels, data channels, information channels related to WLAN throughput and coverage with enhanced SAR). Information may be passed on to other components of the device 605. The receiver 610 may utilize a single antenna or a set of multiple antennas.

The transmitter 615 may provide a means for transmitting signals generated by other components of the device 605. The transmitter 615 may utilize a single antenna or a set of multiple antennas.

The communications manager 620, the receiver 610, the transmitter 615, or various combinations thereof or various components thereof may be examples of means for performing various aspects of WLAN throughput and coverage with enhanced SAR as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (for example, in communications management circuitry). The hardware may include a processor, a digital signal processor (DSP), a central processing unit (CPU), an application-specific integrated circuit (ASIC), a field programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (for example, by executing, by the processor, instructions stored in the memory).

In some examples, the communications manager 620 may be configured to perform various operations (for example, receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a first wireless device in accordance with examples as disclosed herein. For example, the communications manager 620 may be configured as or otherwise support a means for receiving a reference signal associated with measuring a signal strength between the first wireless device and a second wireless device. The communications manager 620 may be configured as or otherwise support a means for determining that an SAR limit associated with communication between the first wireless device and the second wireless device and for a first time interval is less than a threshold. The communications manager 620 may be configured as or otherwise support a means for modifying the SAR limit for the first time interval based on the signal strength failing to satisfy a signal strength threshold and the SAR limit for the first time interval being less than the threshold. The communications manager 620 may be configured as or otherwise support a means for transmitting, during the first time interval, a data frame having a transmission power that is based on the modified SAR limit for the first time interval.

Additionally, or alternatively, the communications manager 620 may support wireless communication at a first wireless device in accordance with examples as disclosed herein. For example, the communications manager 620 may be configured as or otherwise support a means for scheduling a transmission of a control frame to a second wireless device. The communications manager 620 may be configured as or otherwise support a means for suspending, based on the scheduling, a transmission power threshold associated with an SAR limit for communications between the first wireless device and the second wireless device. The communications manager 620 may be configured as or otherwise support a means for transmitting, to the second wireless device, the control frame having a transmission power that is greater than the transmission power threshold based on suspending the transmission power threshold.

By including or configuring the communications manager 620 in accordance with examples as described herein, the device 605 (for example, a processor controlling or otherwise coupled with the receiver 610, the transmitter 615, the communications manager 620, or a combination thereof) may support techniques for increased throughput, communication reliability, and WLAN coverage areas, among other benefits.

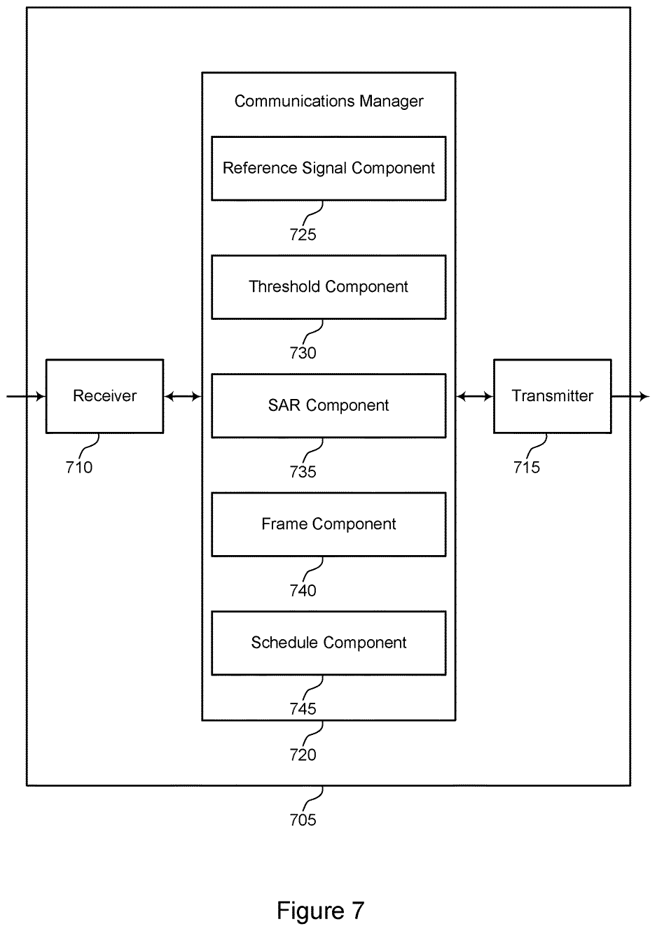

FIG. 7 shows a block diagram of a device 705 that supports WLAN throughput and coverage with enhanced SAR in accordance with one or more aspects of the present disclosure. The device 705 may be an example of aspects of a device 605, an AP, or a STA as described herein. The device 705 may include a receiver 710, a transmitter 715, and a communications manager 720. The communications manager 720 can be implemented, at least in part, by one or both of a modem and a processor. Each of these components may be in communication with one another (for example, via one or more buses).

The receiver 710 may provide a means for receiving information such as packets, user data, control information, or any combination thereof associated with various information channels (for example, control channels, data channels, information channels related to WLAN throughput and coverage with enhanced SAR). Information may be passed on to other components of the device 705. The receiver 710 may utilize a single antenna or a set of multiple antennas.

The transmitter 715 may provide a means for transmitting signals generated by other components of the device 705. The transmitter 715 may utilize a single antenna or a set of multiple antennas.

The device 705, or various components thereof, may be an example of means for performing various aspects of WLAN throughput and coverage with enhanced SAR as described herein. For example, the communications manager 720 may include a reference signal component 725, a threshold component 730, an SAR component 735, a frame component 740, a schedule component 745, or any combination thereof. In some examples, the communications manager 720, or various components thereof, may be configured to perform various operations (for example, receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a first wireless device in accordance with examples as disclosed herein. The reference signal component 725 may be configured as or otherwise support a means for receiving a reference signal associated with measuring a signal strength between the first wireless device and a second wireless device. The threshold component 730 may be configured as or otherwise support a means for determining that an SAR limit associated with communication between the first wireless device and the second wireless device and for a first time interval is less than a threshold. The SAR component 735 may be configured as or otherwise support a means for modifying the SAR limit for the first time interval based on the signal strength failing to satisfy a signal strength threshold and the SAR limit for the first time interval being less than the threshold. The frame component 740 may be configured as or otherwise support a means for transmitting, during the first time interval, a data frame having a transmission power that is based on the modified SAR limit for the first time interval.

Additionally, or alternatively, the communications manager 720 may support wireless communication at a first wireless device in accordance with examples as disclosed herein. The schedule component 745 may be configured as or otherwise support a means for scheduling a transmission of a control frame to a second wireless device. The threshold component 730 may be configured as or otherwise support a means for suspending, based on the scheduling, a transmission power threshold associated with an SAR limit for communications between the first wireless device and the second wireless device. The frame component 740 may be configured as or otherwise support a means for transmitting, to the second wireless device, the control frame having a transmission power that is greater than the transmission power threshold based on suspending the transmission power threshold.

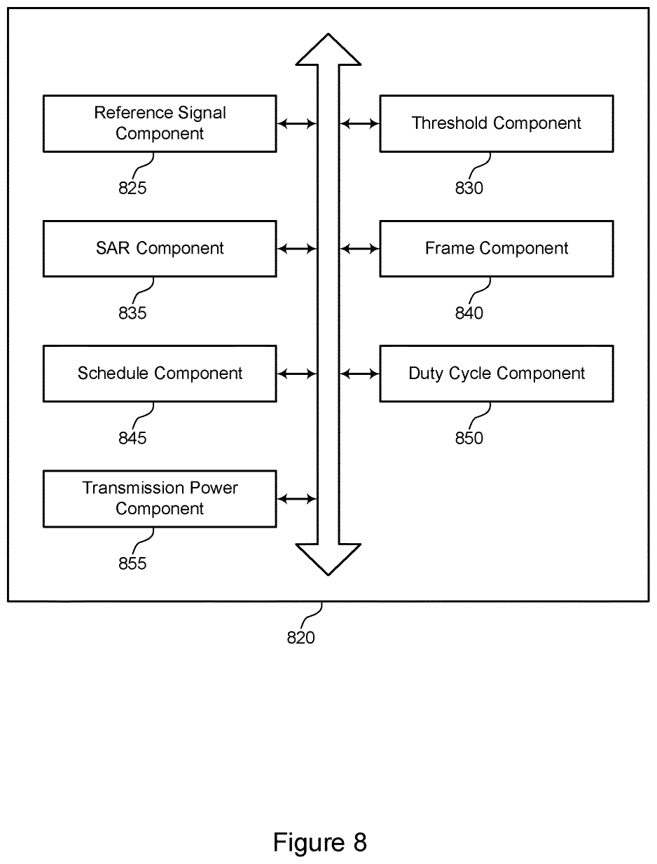

FIG. 8 shows a block diagram of a communications manager 820 that supports WLAN throughput and coverage with enhanced SAR in accordance with one or more aspects of the present disclosure. The communications manager 820, or various components thereof, may be an example of means for performing various aspects of WLAN throughput and coverage with enhanced SAR as described herein. For example, the communications manager 820 may include a reference signal component 825, a threshold component 830, an SAR component 835, a frame component 840, a schedule component 845, a duty cycle component 850, a transmission power component 855, or any combination thereof. Each of these components may communicate, directly or indirectly, with one another (for example, via one or more buses).

The communications manager 820 may support wireless communication at a first wireless device in accordance with examples as disclosed herein. The reference signal component 825 may be configured as or otherwise support a means for receiving a reference signal associated with measuring a signal strength between the first wireless device and a second wireless device. The threshold component 830 may be configured as or otherwise support a means for determining that an SAR limit associated with communication between the first wireless device and the second wireless device and for a first time interval is less than a threshold. The SAR component 835 may be configured as or otherwise support a means for modifying the SAR limit for the first time interval based on the signal strength failing to satisfy a signal strength threshold and the SAR limit for the first time interval being less than the threshold. The frame component 840 may be configured as or otherwise support a means for transmitting, during the first time interval, a data frame having a transmission power that is based on the modified SAR limit for the first time interval.

In some examples, the duty cycle component 850 may be configured as or otherwise support a means for modifying a duty cycle associated with the first time interval based on modifying the SAR limit for the first time interval, where the data frame is transmitted in accordance with the modified duty cycle.

In some examples, to support modifying the duty cycle, the duty cycle component 850 may be configured as or otherwise support a means for reducing the duty cycle to reduce a duration of the first time interval during which the first wireless device transmits signals to the second wireless device, where a duration of the data frame is based on the reduced duty cycle.

In some examples, transmitting the data frame having the transmission power that is based on the modified SAR limit satisfies a time-averaged SAR limit associated with a second time interval including the first time interval based on modifying the duty cycle.

In some examples, the schedule component 845 may be configured as or otherwise support a means for scheduling one or more frames for transmission during the first time interval in accordance with the modified duty cycle, the one or more frames including the data frame.

In some examples, the reference signal component 825 may be configured as or otherwise support a means for receiving a second reference signal associated with measuring the signal strength between the first wireless device and the second wireless device. In some examples, the threshold component 830 may be configured as or otherwise support a means for determining that a second SAR limit for a second time interval is less than a second threshold, where the second threshold is greater than the threshold. In some examples, the SAR component 835 may be configured as or otherwise support a means for modifying the second SAR limit for the second time interval based on the signal strength failing to satisfy the signal strength threshold and the second SAR limit for the second time interval being less than the second threshold. In some examples, the duty cycle component 850 may be configured as or otherwise support a means for modifying a second duty cycle associated with the second time interval based on modifying the second SAR limit for the second time interval. In some examples, the frame component 840 may be configured as or otherwise support a means for transmitting, during the second time interval and in accordance with the second duty cycle, a second data frame having a second transmission power that is based on the modified second SAR limit for the second time interval.

In some examples, the second transmission power of the second data frame is greater than the transmission power of the data frame based on the second threshold being greater than the threshold. In some examples, the second duty cycle is less than the duty cycle based on the second transmission power of the second data frame being greater than the transmission power of the data frame.

In some examples, to support modifying the SAR limit for the first time interval, the SAR component 835 may be configured as or otherwise support a means for setting the SAR limit for the first time interval equal to the threshold.

In some examples, the transmission power of the data frame is greater than a transmission power threshold associated with the unmodified SAR limit.

In some examples, the first wireless device is an AP and the second wireless device is a STA.

In some examples, the first wireless device is a STA and the second wireless device is an AP.

Additionally, or alternatively, the communications manager 820 may support wireless communication at a first wireless device in accordance with examples as disclosed herein. The schedule component 845 may be configured as or otherwise support a means for scheduling a transmission of a control frame to a second wireless device. In some examples, the threshold component 830 may be configured as or otherwise support a means for suspending, based on the scheduling, a transmission power threshold associated with an SAR limit for communications between the first wireless device and the second wireless device. In some examples, the frame component 840 may be configured as or otherwise support a means for transmitting, to the second wireless device, the control frame having a transmission power that is greater than the transmission power threshold based on suspending the transmission power threshold.

In some examples, the transmission power component 855 may be configured as or otherwise support a means for determining, based on suspending the transmission power threshold, the transmission power of the control frame in accordance with a transmission power limit associated with a channel via which the control frame is transmitted, a hardware capability of the first wireless device, or a combination thereof.

In some examples, the transmission power of the control frame is equal to a minimum of the transmission power limit and the hardware capability of the first wireless device.

In some examples, the schedule component 845 may be configured as or otherwise support a means for scheduling a transmission of a data frame to the second wireless device. In some examples, the threshold component 830 may be configured as or otherwise support a means for reinstating, based on the scheduling of the data frame, the transmission power threshold. In some examples, the frame component 840 may be configured as or otherwise support a means for transmitting, to the second wireless device, the data frame having a second transmission power that is in accordance with the transmission power threshold based on reinstating the transmission power threshold.

In some examples, the transmission power threshold is suspended based on a duration of the control frame being less than a threshold duration.

In some examples, the first wireless device is a STA and the second wireless device is an AP.

In some examples, the first wireless device is an AP and the second wireless device is a STA.

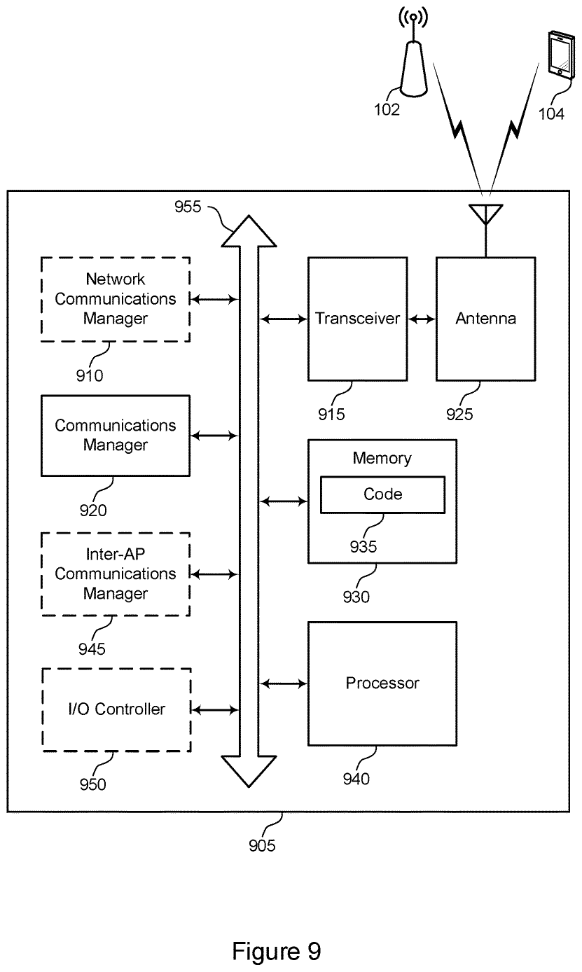

FIG. 9 shows a diagram of a system including a device 905 that supports WLAN throughput and coverage with enhanced SAR in accordance with one or more aspects of the present disclosure. The device 905 may be an example of or include the components of a device 605, a device 705, an AP, or a STA as described herein. The device 905 may include components for bi-directional voice and data communications including components for transmitting and receiving communications, such as a communications manager 920, a network communications manager 910, a transceiver 915, an antenna 925, a memory 930, code 935, a processor 940, an inter-AP communications manager 945, and an input/output (I/O) controller 950. These components may be in electronic communication or otherwise coupled (for example, operatively, communicatively, functionally, electronically, electrically) via one or more buses (for example, a bus 955).

The network communications manager 910 may manage communications with a core network (for example, via one or more wired backhaul links). For example, the network communications manager 910 may manage the transfer of data communications for client devices, such as one or more STAs.

The I/O controller 950 may manage input and output signals for the device 905. The I/O controller 950 may also manage peripherals not integrated into the device 905. In some cases, the I/O controller 950 may represent a physical connection or port to an external peripheral. In some cases, the I/O controller 950 may utilize an operating system such as iOS®, ANDROID®, MS-DOS®, MS-WINDOWS®, OS/2®, UNIX®, LINUX®, or another known operating system. In some other cases, the I/O controller 950 may represent or interact with a modem, a keyboard, a mouse, a touchscreen, or a similar device. In some cases, the I/O controller 950 may be implemented as part of a processor, such as the processor 940. In some cases, a user may interact with the device 905 via the I/O controller 950 or via hardware components controlled by the I/O controller 950.

In some cases, the device 905 may include a single antenna 925. However, in some other cases the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets and provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random-access memory (RAM) and read-only memory (ROM). The memory 930 may store computer-readable, computer-executable code 935 including instructions that, when executed by the processor 940, cause the device 905 to perform various functions described herein. In some cases, the memory 930 may contain, among other things, a BIOS which may control basic hardware or software operation such as the interaction with peripheral components or devices.

The processor 940 may include an intelligent hardware device, (for example, a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (for example, the memory 930) to cause the device 905 to perform various functions (for example, functions or tasks supporting WLAN throughput and coverage with enhanced SAR). For example, the device 905 or a component of the device 905 may include a processor 940 and memory 930 coupled with or to the processor 940, the processor 940 and memory 930 configured to perform various functions described herein.

The inter-AP communications manager 945 may manage communications with other APs, and may include a controller or scheduler for controlling communications with STAs 104 in cooperation with other APs 102. For example, the inter-AP communications manager 945 may coordinate scheduling for transmissions to APs 102 for various interference mitigation techniques such as beamforming or joint transmission. In some examples, the inter-AP communications manager 945 may provide an X2 interface within an LTE/LTE-A wireless communication network technology to provide communication between APs 102.

The communications manager 920 may support wireless communication at a first wireless device in accordance with examples as disclosed herein. For example, the communications manager 920 may be configured as or otherwise support a means for receiving a reference signal associated with measuring a signal strength between the first wireless device and a second wireless device. The communications manager 920 may be configured as or otherwise support a means for determining that an SAR limit associated with communication between the first wireless device and the second wireless device and for a first time interval is less than a threshold. The communications manager 920 may be configured as or otherwise support a means for modifying the SAR limit for the first time interval based on the signal strength failing to satisfy a signal strength threshold and the SAR limit for the first time interval being less than the threshold. The communications manager 920 may be configured as or otherwise support a means for transmitting, during the first time interval, a data frame having a transmission power that is based on the modified SAR limit for the first time interval.

Additionally, or alternatively, the communications manager 920 may support wireless communication at a first wireless device in accordance with examples as disclosed herein. For example, the communications manager 920 may be configured as or otherwise support a means for scheduling a transmission of a control frame to a second wireless device. The communications manager 920 may be configured as or otherwise support a means for suspending, based on the scheduling, a transmission power threshold associated with an SAR limit for communications between the first wireless device and the second wireless device. The communications manager 920 may be configured as or otherwise support a means for transmitting, to the second wireless device, the control frame having a transmission power that is greater than the transmission power threshold based on suspending the transmission power threshold.

By including or configuring the communications manager 920 in accordance with examples as described herein, the device 905 may support techniques for increased throughput, communication reliability, and WLAN coverage areas, among other benefits.

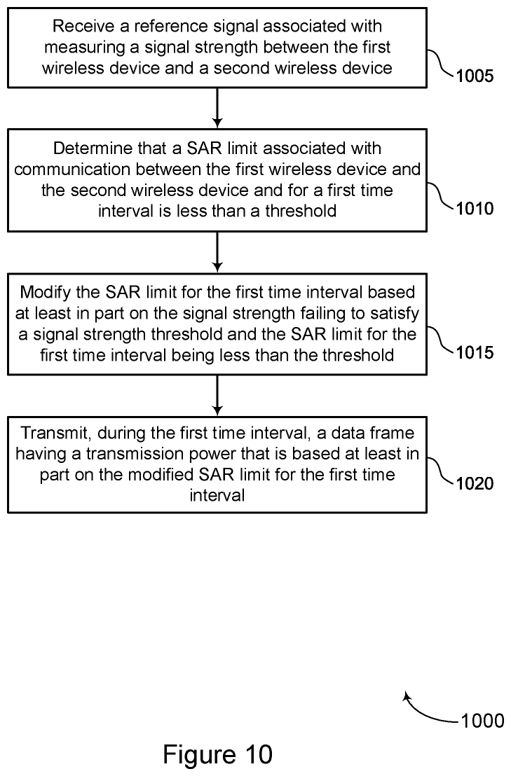

FIG. 10 shows a flowchart illustrating a method 1000 that supports WLAN throughput and coverage with enhanced SAR in accordance with one or more aspects of the present disclosure. The operations of the method 1000 may be implemented by an AP or its components as described herein or a STA or its components as described herein. For example, the operations of the method 1000 may be performed by an AP or a STA as described with reference to FIGS. 1-9. In some examples, an AP or a STA may execute a set of instructions to control the functional elements of the AP or the STA to perform the described functions. Additionally, or alternatively, the AP or the STA may perform aspects of the described functions using special-purpose hardware.

At 1005, the method may include receiving a reference signal associated with measuring a signal strength between the first wireless device and a second wireless device. The operations of 1005 may be performed in accordance with examples as disclosed herein. In some examples, aspects of the operations of 1005 may be performed by a reference signal component 825 as described with reference to FIG. 8.

At 1010, the method may include determining that an SAR limit associated with communication between the first wireless device and the second wireless device and for a first time interval is less than a threshold. The operations of 1010 may be performed in accordance with examples as disclosed herein. In some examples, aspects of the operations of 1010 may be performed by a threshold component 830 as described with reference to FIG. 8.

At 1015, the method may include modifying the SAR limit for the first time interval based on the signal strength failing to satisfy a signal strength threshold and the SAR limit for the first time interval being less than the threshold. The operations of 1015 may be performed in accordance with examples as disclosed herein. In some examples, aspects of the operations of 1015 may be performed by an SAR component 835 as described with reference to FIG. 8.

At 1020, the method may include transmitting, during the first time interval, a data frame having a transmission power that is based on the modified SAR limit for the first time interval. The operations of 1020 may be performed in accordance with examples as disclosed herein. In some examples, aspects of the operations of 1020 may be performed by a frame component 840 as described with reference to FIG. 8.

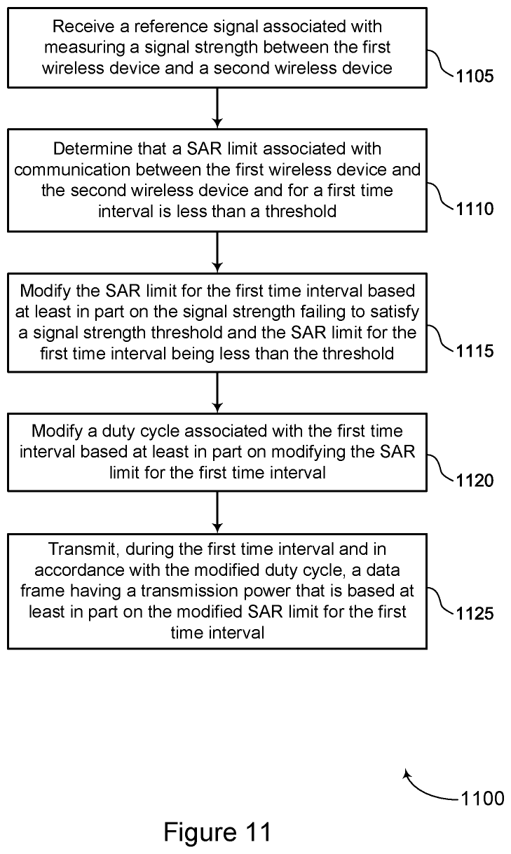

FIG. 11 shows a flowchart illustrating a method 1100 that supports WLAN throughput and coverage with enhanced SAR in accordance with one or more aspects of the present disclosure. The operations of the method 1100 may be implemented by an AP or its components as described herein. For example, the operations of the method 1100 may be performed by an AP as described with reference to FIGS. 1-9. In some examples, an AP may execute a set of instructions to control the functional elements of the AP to perform the described functions. Additionally, or alternatively, the AP may perform aspects of the described functions using special-purpose hardware.

At 1105, the method may include receiving a reference signal associated with measuring a signal strength between the first wireless device and a second wireless device. The operations of 1105 may be performed in accordance with examples as disclosed herein. In some examples, aspects of the operations of 1105 may be performed by a reference signal component 825 as described with reference to FIG. 8.

At 1110, the method may include determining that an SAR limit associated with communication between the first wireless device and the second wireless device and for a first time interval is less than a threshold. The operations of 1110 may be performed in accordance with examples as disclosed herein. In some examples, aspects of the operations of 1110 may be performed by a threshold component 830 as described with reference to FIG. 8.

At 1115, the method may include modifying the SAR limit for the first time interval based on the signal strength failing to satisfy a signal strength threshold and the SAR limit for the first time interval being less than the threshold. The operations of 1115 may be performed in accordance with examples as disclosed herein. In some examples, aspects of the operations of 1115 may be performed by an SAR component 835 as described with reference to FIG. 8.

At 1120, the method may include modifying a duty cycle associated with the first time interval based on modifying the SAR limit for the first time interval. The operations of 1120 may be performed in accordance with examples as disclosed herein. In some examples, aspects of the operations of 1120 may be performed by a duty cycle component 850 as described with reference to FIG. 8.

At 1125, the method may include transmitting, during the first time interval and in accordance with the modified duty cycle, a data frame having a transmission power that is based on the modified SAR limit for the first time interval. The operations of 1125 may be performed in accordance with examples as disclosed herein. In some examples, aspects of the operations of 1125 may be performed by a frame component 840 as described with reference to FIG. 8.

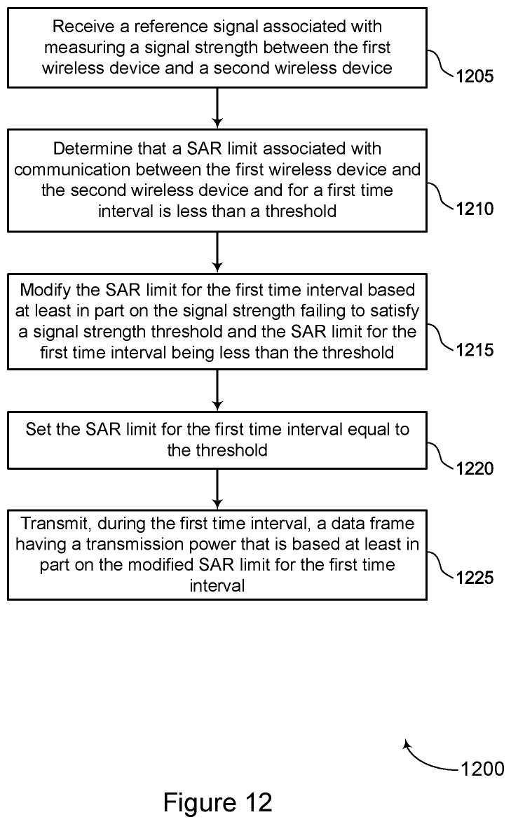

FIG. 12 shows a flowchart illustrating a method 1200 that supports WLAN throughput and coverage with enhanced SAR in accordance with one or more aspects of the present disclosure. The operations of the method 1200 may be implemented by an AP or its components as described herein. For example, the operations of the method 1200 may be performed by an AP as described with reference to FIGS. 1-9. In some examples, an AP may execute a set of instructions to control the functional elements of the AP to perform the described functions. Additionally, or alternatively, the AP may perform aspects of the described functions using special-purpose hardware.

At 1205, the method may include receiving a reference signal associated with measuring a signal strength between the first wireless device and a second wireless device. The operations of 1205 may be performed in accordance with examples as disclosed herein. In some examples, aspects of the operations of 1205 may be performed by a reference signal component 825 as described with reference to FIG. 8.

At 1210, the method may include determining that an SAR limit associated with communication between the first wireless device and the second wireless device and for a first time interval is less than a threshold. The operations of 1210 may be performed in accordance with examples as disclosed herein. In some examples, aspects of the operations of 1210 may be performed by a threshold component 830 as described with reference to FIG. 8.

At 1215, the method may include modifying the SAR limit for the first time interval based on the signal strength failing to satisfy a signal strength threshold and the SAR limit for the first time interval being less than the threshold. The operations of 1215 may be performed in accordance with examples as disclosed herein. In some examples, aspects of the operations of 1215 may be performed by an SAR component 835 as described with reference to FIG. 8.

At 1220, to support modifying the SAR limit, the method may include setting the SAR limit for the first time interval equal to the threshold. The operations of 1220 may be performed in accordance with examples as disclosed herein. In some examples, aspects of the operations of 1220 may be performed by an SAR component 835 as described with reference to FIG. 8.

At 1225, the method may include transmitting, during the first time interval, a data frame having a transmission power that is based on the modified SAR limit for the first time interval. The operations of 1225 may be performed in accordance with examples as disclosed herein. In some examples, aspects of the operations of 1225 may be performed by a frame component 840 as described with reference to FIG. 8.

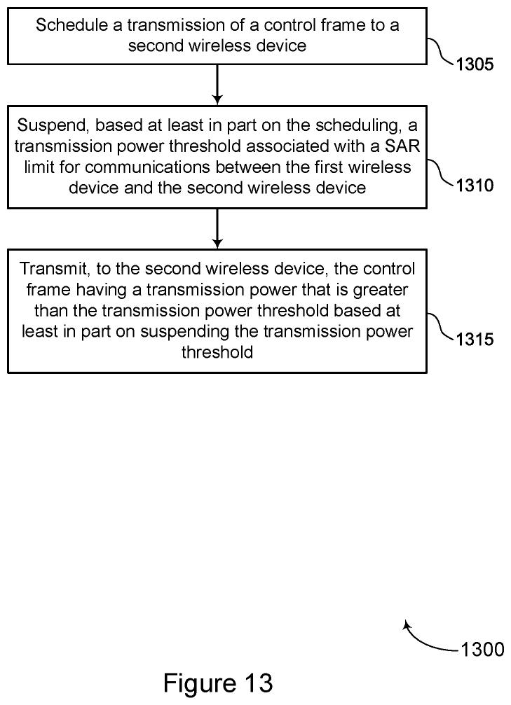

FIG. 13 shows a flowchart illustrating a method 1300 that supports WLAN throughput and coverage with enhanced SAR in accordance with one or more aspects of the present disclosure. The operations of the method 1300 may be implemented by an AP or its components as described herein. For example, the operations of the method 1300 may be performed by an AP as described with reference to FIGS. 1-9. In some examples, an AP may execute a set of instructions to control the functional elements of the AP to perform the described functions. Additionally, or alternatively, the AP may perform aspects of the described functions using special-purpose hardware.

At 1305, the method may include scheduling a transmission of a control frame to a second wireless device. The operations of 1305 may be performed in accordance with examples as disclosed herein. In some examples, aspects of the operations of 1305 may be performed by a schedule component 845 as described with reference to FIG. 8.

At 1310, the method may include suspending, based on the scheduling, a transmission power threshold associated with an SAR limit for communications between the first wireless device and the second wireless device. The operations of 1310 may be performed in accordance with examples as disclosed herein. In some examples, aspects of the operations of 1310 may be performed by a threshold component 830 as described with reference to FIG. 8.

At 1315, the method may include transmitting, to the second wireless device, the control frame having a transmission power that is greater than the transmission power threshold based on suspending the transmission power threshold. The operations of 1315 may be performed in accordance with examples as disclosed herein. In some examples, aspects of the operations of 1315 may be performed by a frame component 840 as described with reference to FIG. 8.

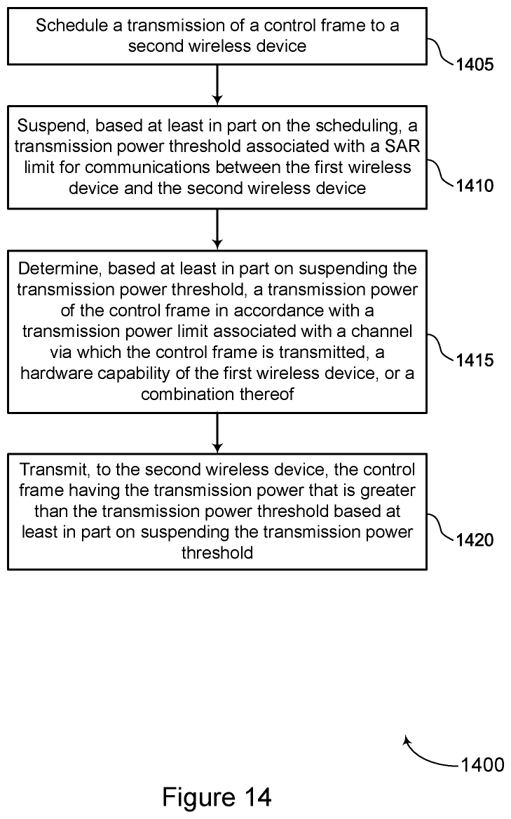

FIG. 14 shows a flowchart illustrating a method 1400 that supports WLAN throughput and coverage with enhanced SAR in accordance with one or more aspects of the present disclosure. The operations of the method 1400 may be implemented by an AP or its components as described herein. For example, the operations of the method 1400 may be performed by an AP as described with reference to FIGS. 1-9. In some examples, an AP may execute a set of instructions to control the functional elements of the AP to perform the described functions. Additionally, or alternatively, the AP may perform aspects of the described functions using special-purpose hardware.

At 1405, the method may include scheduling a transmission of a control frame to a second wireless device. The operations of 1405 may be performed in accordance with examples as disclosed herein. In some examples, aspects of the operations of 1405 may be performed by a schedule component 845 as described with reference to FIG. 8.

At 1410, the method may include suspending, based on the scheduling, a transmission power threshold associated with an SAR limit for communications between the first wireless device and the second wireless device. The operations of 1410 may be performed in accordance with examples as disclosed herein. In some examples, aspects of the operations of 1410 may be performed by a threshold component 830 as described with reference to FIG. 8.

At 1415, the method may include determining, based on suspending the transmission power threshold, a transmission power of the control frame in accordance with a transmission power limit associated with a channel via which the control frame is transmitted, a hardware capability of the first wireless device, or a combination thereof. The operations of 1415 may be performed in accordance with examples as disclosed herein. In some examples, aspects of the operations of 1415 may be performed by a transmission power component 855 as described with reference to FIG. 8.

At 1420, the method may include transmitting, to the second wireless device, the control frame having the transmission power that is greater than the transmission power threshold based on suspending the transmission power threshold. The operations of 1420 may be performed in accordance with examples as disclosed herein. In some examples, aspects of the operations of 1420 may be performed by a frame component 840 as described with reference to FIG. 8.

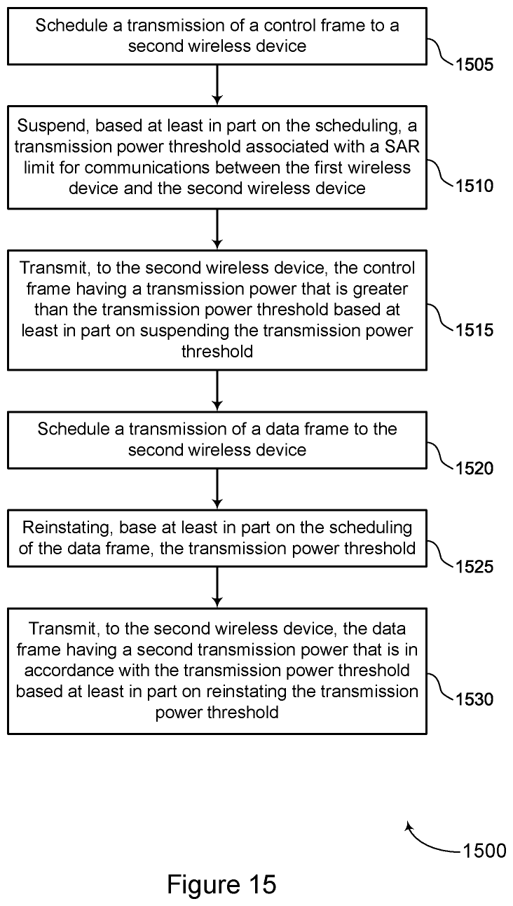

FIG. 15 shows a flowchart illustrating a method 1500 that supports WLAN throughput and coverage with enhanced SAR in accordance with one or more aspects of the present disclosure. The operations of the method 1500 may be implemented by an AP or its components as described herein. For example, the operations of the method 1500 may be performed by an AP as described with reference to FIGS. 1-9. In some examples, an AP may execute a set of instructions to control the functional elements of the AP to perform the described functions. Additionally, or alternatively, the AP may perform aspects of the described functions using special-purpose hardware.

At 1505, the method may include scheduling a transmission of a control frame to a second wireless device. The operations of 1505 may be performed in accordance with examples as disclosed herein. In some examples, aspects of the operations of 1505 may be performed by a schedule component 845 as described with reference to FIG. 8.

At 1510, the method may include suspending, based on the scheduling, a transmission power threshold associated with an SAR limit for communications between the first wireless device and the second wireless device. The operations of 1510 may be performed in accordance with examples as disclosed herein. In some examples, aspects of the operations of 1510 may be performed by a threshold component 830 as described with reference to FIG. 8.

At 1515, the method may include transmitting, to the second wireless device, the control frame having a transmission power that is greater than the transmission power threshold based on suspending the transmission power threshold. The operations of 1515 may be performed in accordance with examples as disclosed herein. In some examples, aspects of the operations of 1515 may be performed by a frame component 840 as described with reference to FIG. 8.

At 1520, the method may include scheduling a transmission of a data frame to the second wireless device. The operations of 1520 may be performed in accordance with examples as disclosed herein. In some examples, aspects of the operations of 1520 may be performed by a schedule component 845 as described with reference to FIG. 8.

At 1525, the method may include reinstating, based on the scheduling of the data frame, the transmission power threshold. The operations of 1525 may be performed in accordance with examples as disclosed herein. In some examples, aspects of the operations of 1525 may be performed by a threshold component 830 as described with reference to FIG. 8.

At 1530, the method may include transmitting, to the second wireless device, the data frame having a second transmission power that is in accordance with the transmission power threshold based on reinstating the transmission power threshold. The operations of 1530 may be performed in accordance with examples as disclosed herein. In some examples, aspects of the operations of 1530 may be performed by a frame component 840 as described with reference to FIG. 8.

Implementation examples are described in the following numbered clauses:
Clause 1: A method for wireless communication at a first wireless device, including: receiving a reference signal associated with measuring a signal strength between the first wireless device and a second wireless device; determining that a specific absorption rate limit associated with communication between the first wireless device and the second wireless device and for a first time interval is less than a threshold; modifying the specific absorption rate limit for the first time interval based at least in part on the signal strength failing to satisfy a signal strength threshold and the specific absorption rate limit for the first time interval being less than the threshold; and transmitting, during the first time interval, a data frame having a transmission power that is based at least in part on the modified specific absorption rate limit for the first time interval.
Clause 2: The method of clause 1, further including: modifying a duty cycle associated with the first time interval based at least in part on modifying the specific absorption rate limit for the first time interval, where the data frame is transmitted in accordance with the modified duty cycle.
Clause 3: The method of clause 2, where modifying the duty cycle includes reducing the duty cycle to reduce a duration of the first time interval during which the first wireless device transmits signals to the second wireless device, where a duration of the data frame is based at least in part on the reduced duty cycle.
Clause 4: The method of any of clauses 2-3, where transmitting the data frame having the transmission power that is based at least in part on the modified specific absorption rate limit satisfies a time-averaged specific absorption rate limit associated with a second time interval including the first time interval based at least in part on modifying the duty cycle.
Clause 5: The method of any of clauses 2-4, further including scheduling one or more frames for transmission during the first time interval in accordance with the modified duty cycle, the one or more frames including the data frame.
Clause 6: The method of any of clauses 2-5, further including: receiving a second reference signal associated with measuring the signal strength between the first wireless device and the second wireless device; determining that a second specific absorption rate limit for a second time interval is less than a second threshold, where the second threshold is greater than the threshold; modifying the second specific absorption rate limit for the second time interval based at least in part on the signal strength failing to satisfy the signal strength threshold and the second specific absorption rate limit for the second time interval being less than the second threshold; modifying a second duty cycle associated with the second time interval based at least in part on modifying the second specific absorption rate limit for the second time interval; and transmitting, during the second time interval and in accordance with the second duty cycle, a second data frame having a second transmission power that is based at least in part on the modified second specific absorption rate limit for the second time interval.
Clause 7: The method of clause 6, where the second transmission power of the second data frame is greater than the transmission power of the data frame based at least in part on the second threshold being greater than the threshold, and the second duty cycle is less than the duty cycle based at least in part on the second transmission power of the second data frame being greater than the transmission power of the data frame.
Clause 8: The method of any of clauses 1-7, where modifying the specific absorption rate limit for the first time interval includes setting the specific absorption rate limit for the first time interval equal to the threshold.
Clause 9: The method of any of clauses 1-8, where the transmission power of the data frame is greater than a transmission power threshold associated with the unmodified specific absorption rate limit.
Clause 10: The method of any of clauses 1-9, where the first wireless device is an access point and the second wireless device is a station.
Clause 11.: The method of any of clauses 1-9, where the first wireless device is a station and the second wireless device is an access point.
Clause 12: A method for wireless communication at a first wireless device, including: scheduling a transmission of a control frame to a second wireless device; suspending, based at least in part on the scheduling, a transmission power threshold associated with a specific absorption rate limit for communications between the first wireless device and the second wireless device; and transmitting, to the second wireless device, the control frame having a transmission power that is greater than the transmission power threshold based at least in part on suspending the transmission power threshold.
Clause 13: The method of clause 12, further including: determining, based at least in part on suspending the transmission power threshold, the transmission power of the control frame in accordance with a transmission power limit associated with a channel via which the control frame is transmitted, a hardware capability of the first wireless device, or a combination thereof.
Clause 14: The method of clause 13, where the transmission power of the control frame is equal to a minimum of the transmission power limit and the hardware capability of the first wireless device.
Clause 15: The method of any of clauses 12-14, further including: scheduling a transmission of a data frame to the second wireless device; reinstating, based at least in part on the scheduling of the data frame, the transmission power threshold; and transmitting, to the second wireless device, the data frame having a second transmission power that is in accordance with the transmission power threshold based at least in part on reinstating the transmission power threshold.
Clause 16: The method of any of clauses 12-15, where the transmission power threshold is suspended based at least in part on a duration of the control frame being less than a threshold duration.
Clause 17: The method of any of clauses 12-16, where the first wireless device is a station and the second wireless device is an access point.
Clause 18: The method of any of clauses 12-16, where the first wireless device is an access point and the second wireless device is a station.
Clause 19: An apparatus for wireless communication at a wireless device, including a processor and memory coupled with the processor and storing instructions executable by the processor to cause the apparatus to perform a method of any of clauses 1-11.
Clause 20: A wireless device including at least one means for performing a method of any of clauses 1-11.
Clause 21: A non-transitory computer-readable medium storing code for wireless communication, the code including instructions executable by a processor to perform a method of any of clauses 1-11.
Clause 22: An apparatus for wireless communication at a wireless device, including a processor and memory coupled with the processor and storing instructions executable by the processor to cause the apparatus to perform a method of any of clauses 12-18.
Clause 23: A wireless device including at least one means for performing a method of any of clauses 12-18.
Clause 24: A non-transitory computer-readable medium storing code for wireless communication, the code including instructions executable by a processor to perform a method of any of clauses 12-18.

It should be noted that the methods described herein describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1X, 1X, etc. IS-856(TIA-856 ) is commonly referred to as CDMA2000 1xEV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, WLANs 100, 200, 300, 400, and 500 of FIGS. 1-5—may include one or more carriers, where each carrier may be a signal made up of multiple sub-carriers (for example, waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (for example, a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (such as, A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication at a first wireless device, comprising:
receiving a reference signal associated with measuring a signal strength between the first wireless device and a second wireless device;
determining that a specific absorption rate limit associated with communication between the first wireless device and the second wireless device and for a first time interval is less than a threshold;
modifying the specific absorption rate limit for the first time interval based at least in part on the signal strength failing to satisfy a signal strength threshold and the specific absorption rate limit for the first time interval being less than the threshold; and
transmitting, during the first time interval, a data frame having a transmission power that is based at least in part on the modified specific absorption rate limit for the first time interval.

2. The method of claim 1, further comprising modifying a duty cycle associated with the first time interval based at least in part on modifying the specific absorption rate limit for the first time interval, wherein the data frame is transmitted in accordance with the modified duty cycle.

3. The method of claim 2, wherein modifying the duty cycle comprises reducing the duty cycle to reduce a duration of the first time interval during which the first wireless device transmits signals to the second wireless device, wherein a duration of the data frame is based at least in part on the reduced duty cycle.

4. The method of claim 2, wherein transmitting the data frame having the transmission power that is based at least in part on the modified specific absorption rate limit satisfies a time-averaged specific absorption rate limit associated with a second time interval comprising the first time interval based at least in part on modifying the duty cycle.

5. The method of claim 2, further comprising scheduling one or more frames for transmission during the first time interval in accordance with the modified duty cycle, the one or more frames comprising the data frame.

6. The method of claim 2, further comprising:
receiving a second reference signal associated with measuring the signal strength between the first wireless device and the second wireless device;
determining that a second specific absorption rate limit for a second time interval is less than a second threshold, wherein the second threshold is greater than the threshold;
modifying the second specific absorption rate limit for the second time interval based at least in part on the signal strength failing to satisfy the signal strength threshold and the second specific absorption rate limit for the second time interval being less than the second threshold;
modifying a second duty cycle associated with the second time interval based at least in part on modifying the second specific absorption rate limit for the second time interval; and
transmitting, during the second time interval and in accordance with the second duty cycle, a second data frame having a second transmission power that is based at least in part on the modified second specific absorption rate limit for the second time interval.

7. The method of claim 6, wherein:
the second transmission power of the second data frame is greater than the transmission power of the data frame based at least in part on the second threshold being greater than the threshold, and
the second duty cycle is less than the duty cycle based at least in part on the second transmission power of the second data frame being greater than the transmission power of the data frame.

8. The method of claim 1, wherein modifying the specific absorption rate limit for the first time interval comprises setting the specific absorption rate limit for the first time interval equal to the threshold.

9. The method of claim 1, wherein the transmission power of the data frame is greater than a transmission power threshold associated with the unmodified specific absorption rate limit.

10. The method of claim 1, wherein the first wireless device is an access point and the second wireless device is a station.

11. The method of claim 1, wherein the first wireless device is a station and the second wireless device is an access point.

12. A method for wireless communication at a first wireless device, comprising:
scheduling a transmission of a control frame to a second wireless device;
suspending, based at least in part on the scheduling, a transmission power threshold associated with a specific absorption rate limit for communications between the first wireless device and the second wireless device; and
transmitting, to the second wireless device, the control frame having a transmission power that is greater than the transmission power threshold based at least in part on suspending the transmission power threshold.

13. The method of claim 12, further comprising determining, based at least in part on suspending the transmission power threshold, the transmission power of the control frame in accordance with a transmission power limit associated with a channel via which the control frame is transmitted, a hardware capability of the first wireless device, or a combination thereof.

14. The method of claim 13, wherein the transmission power of the control frame is equal to a minimum of the transmission power limit and the hardware capability of the first wireless device.

15. The method of claim 12, further comprising:
scheduling a transmission of a data frame to the second wireless device;
reinstating, based at least in part on the scheduling of the data frame, the transmission power threshold; and
transmitting, to the second wireless device, the data frame having a second transmission power that is in accordance with the transmission power threshold based at least in part on reinstating the transmission power threshold.

16. The method of claim 12, wherein the transmission power threshold is suspended based at least in part on a duration of the control frame being less than a threshold duration.

17. The method of claim 12, wherein the first wireless device is a station and the second wireless device is an access point.

18. The method of claim 12, wherein the first wireless device is an access point and the second wireless device is a station.

19. An apparatus for wireless communication at a first wireless device, comprising:
a processor; and
memory coupled with the processor and storing instructions executable by the processor to cause the apparatus to:
receive a reference signal associated with measurement of a signal strength between the first wireless device and a second wireless device;
determine that a specific absorption rate limit associated with communication between the first wireless device and the second wireless device and for a first time interval is less than a threshold;
modify the specific absorption rate limit for the first time interval based at least in part on the signal strength failing to satisfy a signal strength threshold and the specific absorption rate limit for the first time interval being less than the threshold; and
transmit, during the first time interval, a data frame having a transmission power that is based at least in part on the modified specific absorption rate limit for the first time interval.

20. The apparatus of claim 19, wherein the instructions are further executable by the processor to cause the apparatus to modify a duty cycle associated with the first time interval based at least in part on the modification of the specific absorption rate limit for the first time interval, wherein the data frame is transmitted in accordance with the modified duty cycle.

21. The apparatus of claim 20, wherein the instructions to modify the duty cycle are executable by the processor to cause the apparatus to reduce the duty cycle to reduce a duration of the first time interval during which the first wireless device transmits signals to the second wireless device, wherein a duration of the data frame is based at least in part on the reduced duty cycle.

22. The apparatus of claim 20, wherein transmission of the data frame having the transmission power that is based at least in part on the modified specific absorption rate limit satisfies a time-averaged specific absorption rate limit associated with a second time interval comprising the first time interval based at least in part on the modification of the duty cycle.

23. The apparatus of claim 20, wherein the instructions are further executable by the processor to cause the apparatus to schedule one or more frames for transmission during the first time interval in accordance with the modified duty cycle, the one or more frames comprising the data frame.

24. The apparatus of claim 20, wherein the instructions are further executable by the processor to cause the apparatus to:
receive a second reference signal associated with measurement of the signal strength between the first wireless device and the second wireless device;
determine that a second specific absorption rate limit for a second time interval is less than a second threshold, wherein the second threshold is greater than the threshold;
modify the second specific absorption rate limit for the second time interval based at least in part on the signal strength failing to satisfy the signal strength threshold and the second specific absorption rate limit for the second time interval being less than the second threshold;
modify a second duty cycle associated with the second time interval based at least in part on the modification of the second specific absorption rate limit for the second time interval; and
transmit, during the second time interval and in accordance with the second duty cycle, a second data frame having a second transmission power that is based at least in part on the modified second specific absorption rate limit for the second time interval.

25. The apparatus of claim 24, wherein:
the second transmission power of the second data frame is greater than the transmission power of the data frame based at least in part on the second threshold being greater than the threshold, and
the second duty cycle is less than the duty cycle based at least in part on the second transmission power of the second data frame being greater than the transmission power of the data frame.

26. The apparatus of claim 19, wherein the instructions to modify the specific absorption rate limit for the first time interval are executable by the processor to cause the apparatus to set the specific absorption rate limit for the first time interval equal to the threshold.

27. An apparatus for wireless communication at a first wireless device, comprising:
a processor; and
memory coupled with the processor and storing instructions executable by the processor to cause the apparatus to:
schedule a transmission of a control frame to a second wireless device;
suspend, based at least in part on the scheduling, a transmission power threshold associated with a specific absorption rate limit for communications between the first wireless device and the second wireless device; and
transmit, to the second wireless device, the control frame having a transmission power that is greater than the transmission power threshold based at least in part on suspending the transmission power threshold.

28. The apparatus of claim 27, wherein the instructions are further executable by the processor to cause the apparatus to determine, based at least in part on the suspension of the transmission power threshold, the transmission power of the control frame in accordance with a transmission power limit associated with a channel via which the control frame is transmitted, a hardware capability of the first wireless device, or a combination thereof.

29. The apparatus of claim 28, wherein the transmission power of the control frame is equal to a minimum of the transmission power limit and the hardware capability of the first wireless device.

30. The apparatus of claim 27, wherein the instructions are further executable by the processor to cause the apparatus to:
schedule a transmission of a data frame to the second wireless device;
reinstating, base at least in part on the scheduling of the data frame, the transmission power threshold; and
transmit, to the second wireless device, the data frame having a second transmission power that is in accordance with the transmission power threshold based at least in part on reinstating the transmission power threshold.
